(19) United States
(12) Patent Application Publication
(10) Pub. No.: US 2025/0219045 A1
(43) Pub. Date: Jul. 3, 2025

(54) POLYMER-BASED COMPONENTS FOR SOLID-STATE LITHIUM-ION BATTERIES AND METHODS OF MANUFACTURE

(71) Applicant: Piersica, Inc., Tallahassee, FL (US)

(72) Inventor: Claudiu B. Bucur, Sunrise, FL (US)

(21) Appl. No.: 19/080,725

(22) Filed: Mar. 14, 2025

Related U.S. Application Data
(63) Continuation-in-part of application No. 17/243,980, filed on Apr. 29, 2021, now Pat. No. 12,261,321.
(60) Provisional application No. 63/565,272, filed on Mar. 14, 2024.
(60) Provisional application No. 63/018,178, filed on Apr. 30, 2020.

(51) Int. Cl. H01M 4/04; D01D 1/02; D01D 5/00; D04H 1/413; D04H 1/435; D04H 1/56; D04H 1/728; H01M 4/62; H01M 4/66; H01M 4/72; H01M 10/0525

(52) U.S. Cl. CPC H01M 4/0419; D01D 1/02; D01D 5/0038; D04H 1/413; D04H 1/435; D04H 1/56; D04H 1/728; H01M 4/0404; H01M 4/622; H01M 4/661; H01M 4/72; H01M 10/0525; D10B 2505/00

(57) ABSTRACT

A highly conductive solid-state polymer-based electrode lithium-ion batteries and other battery components thereof. The electrode may be deployed in a battery which lacks solvent and allows lithium ions to pass through channels via the polymerized structure. The electrode is formed from a fibrous mat comprising a plurality of lithium-conductive fibers and inter-fiber spaces, wherein the fibrous mat is produced by electrospinning, electrospraying, and hybrid variations thereof of an aged slurry containing a lithium salt, a polymer binder, and a ceramic material. The battery further incorporates a solid-state polymer separator, wherein the lithium conductive polymers are formed through free radical polymerization and comprise a polymerized carbonate solvent between iterative spacers, a lithium conductive material, and a reinforcing additive, with an optional interface coating applied to one or more sides to ensure long-term operation. Various methods for manufacturing the electrodes and separator for solid-state lithium-ion batteries.

### CROSS-REFERENCE TO RELATED APPLICATIONS

To the full extent permitted by law, the present United States Non-Provisional Patent Application hereby claims priority to and the full benefit of, United States Provisional Application entitled “Hybrid Electro-Spinning/Spraying/Splaying Methods, Polymer Compositions, and Manufacture of Battery Components Thereof”, having assigned Ser. No. 63/565,272, filed on Mar. 14, 2024, and additionally is a Continuation-In-Part to U.S. Non-Provisional patent application Ser. No. 17/243,980 entitled “SOLID-STATE POLYMER SEPARATOR FOR LITHIUM-ION BATTERIES” filed on Apr. 29, 2021, which claimed priority to and the full benefit of United States Provisional Patent Application “SAFE, THIN, HIGHLY CONDUCTIVE SOLID-STATE POLYMER SEPARATOR FOR LITHIUM ION BATTERIES,” having assigned Ser. No. 63/018,178, filed on Apr. 30, 2020, which are incorporated herein by reference in their entirety.

### TECHNICAL FIELD OF THE DISCLOSURE

The instant disclosure relates to chemistry, namely electrical current producing apparatuses. More particularly, the instant disclosure relates to the manufacture of battery components having certain improvements to the manufacture of an electrode in order to increase performance, safety, reliability, and conductivity of the overall battery.

### DESCRIPTION OF THE RELATED ART

A lithium-ion battery, or Li-ion battery, is a type of rechargeable battery commonly used in portable electronics and electric vehicles. Compared with previous battery technologies, lithium-ion batteries generally offer faster charging, larger capacity, and higher power density which allow for greater performance in a smaller and lighter package. While there are a large number of reasons that lithium has become a favorable element in battery technology, the most important reasons have to do with its elemental structure. Lithium is highly reactive because it readily loses its outermost electron, allowing current to easily flow through a battery. As the lightest metal, lithium is much lighter than the other metals commonly used in batteries (e.g., lead). This property is important for small objects such as phones but also for cars that require many batteries. Finally, lithium ions and electrons move easily between positive and negative electrodes, allowing for numerous recharging cycles. Innovation in lithium-ion battery technology has helped to minimize the form factor of electronic devices while simultaneously increasing their capabilities. Smart phones, smart watches, wearable devices, and other modern electronic luxuries simply would not be possible without some of the lithium-ion battery advances witnessed in recent decades.

Conventional lithium-ion batteries use a liquid electrolyte. The liquid electrolytic solution in a liquid electrolyte lithium-ion battery is used to regulate the current flow during charging and discharging. Current “flows” through the liquid electrolytic solution between the anode and cathode in order to allow a battery user to store and then use the electrical energy stored with the battery. More specifically, lithium ions move from the negative electrode (the anode) through an electrolyte to the positive electrode (the cathode) during discharge, and back when charging. These lithium-ion batteries usually use an intercalated lithium compound as the material at the cathode and graphite at the anode. Graphite in its fully lithiated state of LiC₆ correlates to a maximal capacity of 372 mAh/g.

While liquid lithium-ion batteries have a high energy density, no memory effect, and low self-discharge, they can be a safety hazard since they contain flammable electrolytes. If damaged and exposed to air or incorrectly charged, these batteries can lead to or even cause explosions and fires. Removable lithium-ion battery recalls due to fire hazard are common and costly, and several portable electronics manufacturers have even been forced to recall expensive electronic devices without removable batteries due to lithium-ion fires. This issue is of increasing concern due to incorporation of liquid lithium-ion batteries in electric vehicles (EVs). During and immediately after an accident, an EV's liquid lithium-ion battery may be readily ignited when exposed to water in the air, thus posing a major safety problem. This safety issue is becoming more important to address as electric vehicles become increasingly commercially viable and more widely adopted.

Some research and development into solid-state lithium battery technology has focused on development of battery components suitable for facilitating a solid-state lithium-ion battery free of liquid-electrolyte. Electrical battery components, namely anode(s), cathode(s), electrolyte(s), separator(s), and current collectors each play a role in the conduction of electrons in order to receive electrical power, chemically store it, and discharge it in order to power various devices of the disclosure. At a very basic level, anodes may be best understood as a negative electrode of a battery where oxidation and reduction takes place during a discharge and charge, respectively. A cathode can be understood as the positive electrode where a reduction and oxidation takes place during discharge and charge, respectively. Separators are usually ionic conductors but electronic insulators capable of providing an electronic separation between battery anode(s) and cathode(s) to prevent internal shorts between each solid-state component. Current collectors are usually substrates that transfer electrons to/from the electrodes to the external circuit.

Much of the research and development to address these concerns with liquid lithium-ion batteries has been focused on the development of batteries having solid, rather than liquid electrodes (i.e., cathodes and anodes). Lithium, in its solid-state has a maximum possible capacity of 3600 mAh/g, or nearly ten times that of graphite. However, lithium metal is also highly reactive in its solid-state and it plates very unevenly. Even in liquid electrolyte lithium-ion batteries, if Lithium plating rates exceed what would normally be considered low critical currents (0.5 mA/cm²), lithium can nucleate and form dendritic or mossy structures rather than smooth or flat plates. This is many times the reason for swelling, expansion, and even puncturing of liquid lithium-ion batteries. In solid lithium anode batteries, this current rate is even smaller (0.1 mA/cm²). Therefore, much like many advances in liquid electrolyte lithium-ion batteries have decreased the potential for dendritic or moss-like formations, advances in prevention of this occurrence are even more important if solid-state lithium-ion anodes were to be produced. A battery having a very large energy storage capacity simply would be advantageous if charging and discharging rates were in the faster range of what consumers and manufacturers have come to expect in modern liquid lithium-ion batteries.

Additionally, manufacture of solid electrode(s) may require a battery separator having a structure, chemistry, and composition sufficient to enable incorporation of these solid-state components. Some separators developed previously for liquid lithium-ion batteries have included polymer sheets, often constructed of highly-flammable polyethylene and/or polypropylene (PE/PP). These sheets offer varying porosity (e.g., 35%-60% porosity). These polymer sheet separators use filler electrolyte, often times containing lithium salts (e.g. LiPF₆) dissolved in organic solvents (e.g. ethyl methyl carbonate or dimethyl carbonate). Thicknesses vary and may be as thin as 15 μm. These porous polymer sheet separators are usually still “perfect” insulators, despite these pores, meaning they do not conduct lithium ions or electrons or allow transport of lithium ions or electrons across the separator. Instead, lithium ions travel through the liquid electrolyte which fills the pores of the porous polymer sheet separator. The bulk conductivity of liquid electrolytes in organic solvents is around 10 mS/cm at room temperature. However, when they fill insulating porous polymer sheet separators, the overall lithium conductivity across the separator can drop by as much as 100× to values neighboring 0.1 mS/cm at room temperature. In addition, porous polymer sheet separators suffer from areal shrinkage at temperatures as low as 100 C which runs the risk of internal shorts and thermal runaway if the anode touches the cathode during use. Furthermore, the use of PE/PP separators usually requires an organic solvent in liquid form, meaning they may not be appropriate if a solid form factor is desired, for the reasons discussed above.

As it relates to certain existing manufactures of solid-state lithium batteries, a well-established technique called tape casting is frequently employed. In this process, a slurry composed of active materials, binders, and solvents is uniformly spread (or “cast”) onto a metallic current collector, such as aluminum or copper foil. After casting, the film is dried to remove the solvent, leaving behind a porous layer of active material. This layer is subsequently calendered (compressed) to reduce thickness variations and enhance the contact between particles, ultimately improving the film's electrical and ionic conductivity. However, tape casting can present drawbacks, including limited control over particle orientation and microstructure, which may result in suboptimal electrode performance. Additionally, the method's reliance on solvent evaporation and subsequent calendering can introduce inconsistencies in film uniformity and mechanical integrity, challenges that the present disclosure aims to address through electric-field-based manufacturing methods using advanced formulations and techniques.

As it may additionally relate to certain manufacturing techniques of solid-state lithium battery production, while conventional battery manufacturing processes have made significant strides, e.g., tape casting, the prior art has additionally not fully leveraged electric field-driven techniques for electrode fabrication, production, and/or manufacture. Traditional methods as well as those at the cutting edge of battery technology may often rely on water-based solutions or employ low concentrations of ceramics and salts, resulting in fiber mats and electrode layers that lack the structural and conductive advantages required for optimal Li+ transport. Additionally, many fail to utilize and/or fully leverage all the advantages of advanced electrospinning and electrospraying techniques to deposit fibers and droplets with precise control over material composition and morphology, as well as hybrid versions thereof and other techniques as may be described herein.

Therefore, it is readily apparent that there is a recognized unmet need for improvements to battery components to allow for optimized solid-state batteries which allow for bulk migration pathways of lithium ions and additionally to achieve a comprehensive integration of precise material control, high ceramic and salt loading, and advanced electric field-driven deposition techniques necessary to fully realize the full potential of electrode architectures that optimize Li+ transport and corresponding solid state lithium battery performance. The current disclosure is designed to address this need through various improvements to the components and internal structure, which include the battery components disclosed herein while addressing at least some of the aspects of the problems discussed above.

### SUMMARY

Briefly described, in a possibly preferred embodiment, the present disclosure overcomes the above-mentioned disadvantages and meets the recognized need for such battery components by introducing various improvements to the manufacture, construction, and design of batteries to accommodate a solid separator in a solid-state lithium-ion battery. These generally include but are not limited to a lithium-ion conductor, an electronic conductor, mixed ionic/electronic conductors, lithium coatings, current collectors, improved welds, incorporation of novel and/or newly adapted lithium conductive polymers for separators, solid polymer electrolytes (SPE) composites, and interface coatings, either separately or in combination. By integrating these improvements into a solid-state lithium-ion battery, these improvements have the potential to increase the energy storage capacity of a lithium-ion battery from its theoretical maximum in liquid electrolyte form to its more energy dense solid form without sacrificing conductivity across the solid separator. Additionally, these improvements, alone and/or in combination, help to decrease the potential for harm, such as fire, resulting from expansion, swelling, or damage to a lithium-ion battery. These improvements, alone and/or in combination, may allow for these benefits without the sacrifice of decreasing charging speed, reducing conductivity, adding bulk or weight, and decreasing power supply to devices.

One aspect of a high energy density lithium metal-based electrode for solid-state lithium-ion batteries may be a lithium-ion conductor. The lithium-ion conductor may be manufactured in a variety of forms, each having corresponding benefits and tradeoffs, though some manufacturing techniques may be potentially preferred as discussed below. These variations in forms may be better understood to be separate distinct embodiments of the lithium-ion conductor. The lithium-ion conductor may be comprised of a ceramic/salt/polymer composite framework, or simply composite framework. The composite framework, or skeleton, may be utilized to support the lithium metal of the lithium-ion conductor. Lithium metal may provide the electronic conductivity while the solid composite framework/skeleton may provide volumetric support and lithium-ion conductivity, which may or may not be necessary. One means to combine and/or operably engage lithium metal with the composite framework/skeleton may be through melt infusion of lithium metal into a treated composite framework. Initially, only a small quantity of lithium metal may be needed to be infused into the pre-cell assembly. In such a case where only a small quantity is infused into the pre-cell assembly of the lithium-ion conductor, all reversible lithium which gives a cell its capacity may instead come from the cathode in the final assembly. This may occur through high voltage insertion cathodes such as lithium ferrophosphate (LFP), lithium cobalt oxide (LCO), nickel/manganese/cobalt (NMC), the like and/or combinations thereof varieties of cathodes. The higher surface area of the composite skeleton may allow for higher rates of operation (plating/stripping of lithium) of the solid battery if compared to a flat lithium foil. From the point of view of energy density, an important requirement for composite skeletons may be the use of low-density ceramic. A proposed example low-density lightweight ceramic may be Li₁₊ₓ AlₓTi₂₋ₓ P₃O₁₂ (LATP). Other example low-density lightweight ceramics include but are not limited to SiO₂, SnO₂, TiO₂, ZnO, Fe₂O₃, Ga₂O₃, BN, GaN, VN and others as may be understood by those having ordinary skill in the art. In this embodiment of the lithium-ion conductor having a composite framework/skeleton, there may be additional components, methods of manufacture, and further variation that include various benefits and tradeoffs. These may include choice in active material and type of functional material processing. Additionally, a polymer rich framework or skeleton may be preferred in order to optimize the 3-dimensional structure of electrodes of the disclosure. A polymer skeleton/framework of the lithium conductor of the electrode(s) may offer the added benefit of being flexible, where a composite framework/skeleton may be described as rigid. Requirements of a polymer framework/skeleton may be (a) having a melting point above the melting point of lithium metal (180 C), (b) non-conductivity of lithium-ions, and (c) infusion with lithium conductive material into the structure, such as other conductive polymers with the corresponding lithium salt (e.g., Lithium bis(trifluoromethanesulfonyl)imide/LiC₂F₆NO₄S₂/LiTFSI, LiDFOB, LiPF6, LiNO3 and other lithium salts) or ceramic particles imbedded into the polymer and/or upon its surface. In this embodiment of the lithium-ion conductor having a polymer framework/skeleton, there may be additional components, methods of manufacture, and further variation that include various benefits and tradeoffs. These may include a fiber mat which may further include PI, aramids, and polyimide frames. As may be understood by those having ordinary skill in the art, certain hybrids of these skeletons and/or frameworks designed to optimize the benefits and reduce corresponding tradeoffs may be possible and are covered in relation to certain potentially preferred embodiments of the disclosure. These distinctions will become more apparent to one skilled in the art from the following Brief Description of the Drawings, Detailed Description of exemplary embodiments thereof, and Claims when read in light of the accompanying Drawings or Figures.

Then, as it relates to electrospinning, this technology is a voltage-driven fabrication process governed by a specific electrohydrodynamic phenomenon where small fibers are yielded from a polymer solution. Electrospinning may be performed by the main steps of connecting a high-voltage source to a polymer solution, forming an electric field, forming a cone shape at a needle tip of a syringe holding the solution, ejecting a charged jet, stretching the jet and solidifying it. Many machines may exist to accomplish electrospinning techniques, but equipment may generally include a vessel to hold the polymer solution, a high-voltage supply to charge it, a syringe to extrude it, and a collector to enable solidification. Applicable to many industries, including at least textiles, medicine, and cosmetics, recent investigations have yielded advances in battery component manufacture. Many techniques for and/or sub-techniques of electrospinning may exist, including but not limited to alternating current electrospinning, needleless and/or nozzle-free electrospinning) electrospinning, multiple needle electrospinning, high-throughput roller electrospinning, wire electrospinning, bubble electrospinning, ball electrospinning, high speed electrospinning, plate edge electrospinning, bowl electrospinning, hollow tube electrospinning, rotary cone electrospinning, spiral coil electrospinning, electroblowing, and/or various combinations thereof. Resulting electro-spun nanofibers may have the advantage of having a large surface area and remain flexible, making them these and many other applications, including advanced battery technology. In some applications, microscale fiber mats can be obtained with electrospinning to achieve exceptional lithium conductivity with additional structural advantages. These advantages may often include an expansive surface area coupled with an intricate porous network. Fiber mats obtained via electrospinning, alone or in combination with other manufacturing techniques, may additionally be architecturally primed to provide numerous pathways for Li-ion diffusion within the fibrous mats and/or the inter-fiber spaces thereof. In addition to structural and Li-ion diffusion advantages, such electro-spun fiber mats may enable faster charge transfer within the electrode, optimizing its performance. Electrospinning may also be adapted chemically to various polymer constituents, enabling adaptation to specific purposes, electrolytes, and/or structural advantages (e.g., weight, density, strength, flexibility, etc.).

Electrospraying is another technique that may be used in the production of electrodes and other battery components, or the underlying polymer and/or chemical structures thereof. Electrospraying, or electrodynamic spraying and/or electrospray ionization, is a technique that uses electricity to create a spray of tiny droplets and/or particles. Fundamentally, it may be performed by initially supplying a liquid through an emitter, applying high-voltage to the liquid, forming a Taylor cone at the emitter tip, emitting a liquid jet from the cone, breaking the jet into droplets and forming small particles on a collector from the droplets. Other applications of electrospraying may include pharmaceuticals, food, and biomedicine. Equipment for electrospraying may include generally, a high-voltage power supply, a syringe with a metallic capillary, a syringe pump to control liquid flow, and a grounded collector. Particles generated from this technique may range from tens of nanometers to a few micrometers in diameter. Certain other methods of and/or sub-techniques for electrospraying may include variations in needle and/or collector voltage(s), distances between thereof, flow rate and/or syringe size/type, collector type, airflow during drying, and environmental conditions (e.g., temperature, barometric pressure, humidity). Additionally, the electric field's acceleration and thinning of the jet, combined with radial charge repulsion, can cause the primary jet to break into several filaments in order to form fibers due to a phenomenon referred to herein as “splaying” of electrospun materials into fibers thereof the filaments. Such approaches, including combined processes of electrospinning, and electrospraying, may yield electrode architectures with expansive surface areas, intricate porous networks, and uniformly distributed active materials, thereby substantially enhancing Li+ conductivity and overall battery efficiency, which may not be fully recognized in the art prior to the instant disclosure.

Then, as it relates to separators manufactured using the disclosed methods and techniques, one aspect of a solid separator for solid-state lithium-ion batteries may be an incorporation of novel lithium conductive polymers, as they may be used in connection with, combination with and/or separately from certain ceramics identified above. The lithium conductive polymers may be manufactured in a variety of forms, each having corresponding benefits and tradeoffs. These variations in forms may be better understood to be separate distinct embodiments of the lithium conductive polymers or may be used in combination to achieve a balance of advantages and tradeoffs. In some embodiments, the lithium conductive polymers may comprise polymerized carbonate blocks (i.e., polymers derived through the polymerization of carbonate solvents) rather than polyethylene glycol-based blocks (polyethylene oxides or PEOs). Carbonate solvents have higher polarity and provide higher conductivity for lithium ions. Carbonate solvents also have improved oxidative stability due to the delocalization of free electrons over the carbonyl group. Thus, polymer blocks from carbonate solvents such as vinylene carbonate, ethylene carbonate or propylene carbonate (as well as other carbonates) may be preferable to PEO with respect to solid-state lithium-ion separator construction. Additionally, carbonates may further possess a conductivity advantage over PEOs. Due to the increased conductivity, many benefits may be derived in the context of the use, manufacture, and implementation of high voltage cathodes (e.g., cathodes of nickel-manganese-cobalt, nickel-cobalt-aluminum oxides, and/or lithium-cobalt-oxide). Ether-based solvents and polymers derived therefrom (such as PEO) are generally not compatible with high-voltage cathodes and can only be used with lower voltage cathodes (e.g. lithium iron phosphate cathodes). Carbonate derived polymers encourage electron delocalization and have higher oxidative stability, thereby enabling these higher voltage cathode technologies to be deployed, with the appropriate separator technology. One exemplary method of polymerizing such a carbonate solvent is by polymerizing the alkene bond in the solvent via free radical polymerization. Various improvements to the use of these carbonate solvents in polymerized form will become more apparent to one skilled in the art from the following Brief Description of the Drawings, Detailed Description of exemplary embodiments thereof, and Claims when read in light of the accompanying Drawings or Figures, including increases in solubility, chemical structural considerations, increases in lithium conductivity, and inclusion of spacer and ring monomers.

In another aspect of solid separators of the disclosure, solid polymer electrolytes (SPE) composites may be utilized in the manufacture thereof. The solid polymer-based separator may contain lithium conductive materials which have electron insulating properties. Those having a low material density may be required to yield cells with high energy density. Generally, the lowest density solid materials manufactured today are polymers having chemical structures (microstructures), which contribute to low-density macrostructures. Therefore, polymers which are capable of conducting lithium may be a suitable material for forming the structure for one such separator of a solid-state cell with high energy density. Lithium conductivity in a polymer may be facilitated or made possible by Li+ coordinating or conductive sites within the structure having high mobility. Such groups may include ethereal oxygens, carbonate oxygens, or silicon-based polymers with similar functionalities such as siloxanes. Other Li+ conductive sites on a polymer may be nitrogen-, phosphorous-, or sulfur-based such as found in polydopamines, polyimides, polyphosphazenes or polysulfonates. Separators having thickness of less than 20 microns may be preferable as they may allow for both free standing structure and stability in humid air. The manufacture of such a structure may also contribute to an easy adoption by the existing battery industry. An existing problem which has prevented adoption of such a separator material in the battery industry may be that polymers with high lithium conductivity generally have short chains, which may prevent them from forming thin, free standing films. The strength modulus of these lithium conductive polymers may be improved by creating composites via mixing with inorganic materials. It may be desirable that these inorganic materials share the lithium conductivity and low-density properties. Such inorganic additives may be lithium aluminum titanium phosphate (LATP, Li_{1.5}Al_{0.5}Ti_{1.5}(PO₄)₃), lithium lanthanum zirconium oxide (LLZO, Li₇La₃Zr₂O₁₂), LSPSCl (Li_{9.54}Si_{1.74}P_{1.44}S_{11.7}Cl_{0.3}), LGPS (Li₁₀GeP₂S₁₂), SiO₂, MnO₂, ZnO₂ aluminum nitride, vanadium nitride, and/or lithium conductive halides and closo-/nido-borates. Electronic insulating carbon-based additives and clays may also be used. Finally, it may be important that the inorganic additives remain as a small fraction of the composite, such as at less than 10% of total separator by weight, volume, and/or mass.

In certain various potentially preferred embodiments of this aspect, namely the solid separators of the disclosure and manufacturing thereof, various manufacturing techniques and standards may be important to manufacture of both a solid separator and a solid-state lithium-ion battery. These may include electrospinning of the conductive polymer and SPE and/or blade casting the conductive polymer and SPE. Those skilled in the art may understand that certain polymers, certain SPEs, and certain combinations of the same may require one, the other, or a combination of these techniques. As may be understood by those having ordinary skill in the art, such separators may additionally include one or more interface coatings, since lithium conductivity may be maximized across a thin (<20 micron) solid separator. At this thickness, the interface with the anode or cathode may require additional treatment to ensure long term operation. This may be a serious issue for stability, longevity, durability, and safety, especially at the interface with exposed lithium metal anode. Several coatings may stabilize and promote this interface. These include carbon materials and macromolecules such as graphites and graphenes, nitrides, borates, alloys, sulfur-based coatings, fluoroethylene carbonate with a cathode stabilizer additive, the like and/or combinations thereof. Various improvements to the interface coatings will become more apparent to one skilled in the art from the following Brief Description of the Drawings, Detailed Description of exemplary embodiments thereof, and Claims when read in light of the accompanying Drawings or Figures.

Alone, or in combination with features related to solid-state lithium-ion batteries generally, various aspects and features of the solid separator for solid-state lithium-ion batteries over both traditional liquid electrolyte lithium-ion batteries, as well as over existing, available, experimental, and/or proposed solid-state lithium-ion batteries and their respective separators. A benefit of the solid separator for solid-state lithium-ion batteries may be its ability to increase the energy density of batteries above that of currently commercial batteries having liquid cells. Another benefit of the solid separator for solid-state lithium-ion batteries may be its ability to enable high currents of operation above the currently observed 0.1-0.5 mA/cm² for solid-state batteries and nearing as high as 10 mA/cm², which may be of significant commercial significance for charging a high energy density battery in less than 30 minutes. Another feature of the solid separator for solid-state lithium-ion batteries may be its ability to enable a safe lithium metal battery structure with lithiophilic interfaces which may result in high cycle life (e.g., greater than 4000 cycles), which may also be of commercial significance for electric vehicles and other durable goods requiring longevity of installed batteries. Another feature of the solid separator for solid-state lithium-ion batteries may be the ability to operate over a much wider temperature range (e.g., −60° C. to 150° C.) than even currently available commercial liquid-based batteries (−30° C. to 60° C.). Another feature of the solid separator for solid-state lithium-ion batteries may be the ability to enable a pre-lithiated anode during manufacture. Another feature of the solid separator for solid-state lithium-ion batteries may be its ability to enable the manufacture of bipolar cells. Bipolar cells utilize bipolar current collectors, which have an anode on one side and a cathode on the other. This may otherwise not be possible, and it is not known to be possible with liquid containing separators because the liquid flows between stacks and creates ionic shorts as well as decomposes the electrolyte. A solid separator which does not contain liquid enables bipolar cells which is one factor which may enable higher rates of charging due to lower internal resistances across the bipolar cell. A bipolar cell may also be safer for a number of reasons, including because it operates with less cell joule heating. Another feature of the solid separator for solid-state lithium-ion batteries may be, in certain embodiments, polymer/inorganic composites which may contain fire retardants which are not flammable and are safer than liquid containing separators. Another feature of the solid separator for solid-state lithium-ion batteries may be enabling other elements of the battery to be solid-state lithium ion (e.g., solid anode, solid cathode). Finally, various other feature of the solid separator for solid-state lithium-ion batteries may include the additional potential benefits of, by way of example and not limitation, low density and lightweight materials, high energy density, the ability to manufacture in sheets having large surface areas, the ability to manufacture in untreated atmospheric air, high electrochemical stability, solvation of high ratios of lithium per weight or molar ratio, high stability of lithium at interface with anode/cathode, high strength, and/or combinations thereof.

In certain aspects of the disclosed improvements to the manufacture of solid-state lithium battery electrodes, separators and other components thereof, the disclosure may employ certain advanced electrospinning techniques, which may utilize various organic solvent-based polymer solutions alongside high concentrations of ceramics and salts. This approach may yield microscale fiber mats with expansive surface areas, intricate porous networks, and uniformly distributed active materials that facilitate superior Li+ transport and markedly enhanced electrode efficiency.

In another aspect thereof, the disclosed systems, methods, and products thereof may utilize electrospraying to deposit electrode material droplets with high precision onto designated substrates. This method may in turn form conformal layers that ensure optimal coverage and uniform active material distribution, thereby maintaining consistent Li+ conductivity across the electrode surface. Related thereto, and in certain potentially preferred embodiments of the disclosed methods and manufactured products thereof, the potentially preferred methods may integrate certain hybrid processes that combine both electrospinning and electrospraying. This dual-modality approach may synergistically enhance the structural and conductive properties of the electrode, resulting in improved charge transfer, elevated energy density, and overall battery performance. In embodiments related thereto such preferred embodiments, the disclosed methods may allow for precise control over material composition and morphology. Tailored electrode designs can be achieved to meet specific performance criteria, thereby overcoming the shortcomings of traditional water-based or low-loading processes and fully leveraging the benefits of advanced electric field-driven fabrication techniques.

In yet another aspect and/or in relation to the hybrid electrospraying techniques summarized above, the instant disclosure also further improves electrode performance through a splaying technique during fiber mat formation. By intentionally dispersing and spreading the fibers, splaying according to certain disclosed processes identified and described herein may create a more open, loosely-packed architecture in order to further increase the surface area and porosity of the electrode of various solid-state lithium batteries of the disclosure, as well as other battery components as may be understood by those having ordinary skill in the art. This configuration can enable more effective electrolyte infiltration and more efficient Li+ ion transport, thereby reducing internal resistance and enhancing overall charge transfer efficiency within the battery. These and other features of the components for solid-state lithium-ion batteries will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The solid separator for solid-state lithium-ion batteries will be better understood by reading the Detailed Description with reference to the accompanying drawings, which are not necessarily drawn to scale, and in which like reference numerals denote similar structure and refer to like elements throughout, and in which:

FIG. 1 is a perspective view of a section of an exemplary embodiment of a high energy density lithium metal-based battery for solid-state lithium-ion battery of the disclosure;

FIG. 2 is a diagram of components of a prior art battery;

FIG. 3 is a perspective view of a section of an exemplary embodiment of the solid separator for solid-state lithium-ion batteries;

FIG. 4A is a block drawing of a battery;

FIG. 4B is a side sectional schematic view of an electrospraying system;

FIG. 4C is a side sectional schematic view of an electrospinning system;

FIGS. 5A-B are method flowcharts of exemplary manufacturing methods of the disclosure; and

FIGS. 6A-G are low-magnification and high-magnification images of various fiber mats of the disclosure from various micrographs after various exemplary manufacturing processes.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

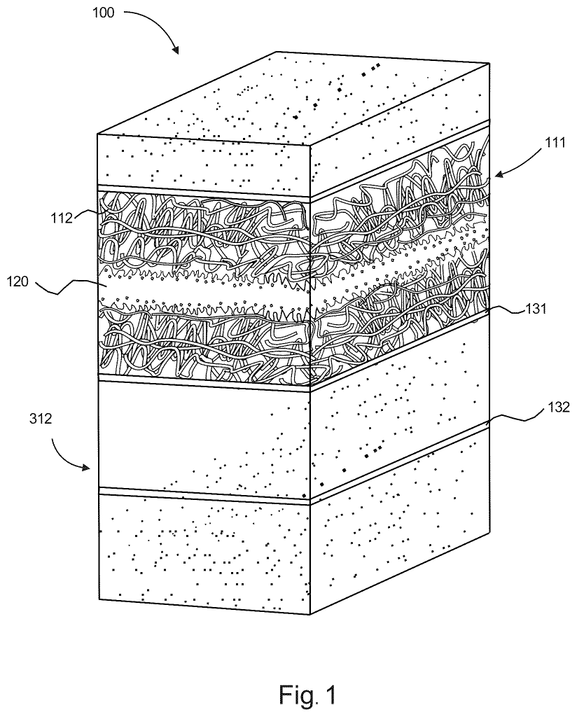

In describing the exemplary embodiments of the present disclosure, as illustrated in FIGS. 1-6, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples. It should be noted that the terms battery, cell, anode, cathode and separator, in their singular and plural form, are used as they relate to the high energy density lithium metal-based anode for solid-state lithium-ion batteries of the disclosure, as well as used to describe other batteries, including but not limited to lithium-ion batteries having a liquid electrolyte. While a single cell of a battery may be herein described, one skilled in the art of battery manufacture will understand that multiple cells may be used in the design, construction, manufacture, and assembly of a battery, and multiple batteries may be arranged and/or installed within a completed manufactured good. While fiber framework and fiber sheet(s) are used consistently throughout this detailed description, they may also be understood as a fibrous battery skeleton and separator micro-structure, respectively.

Referring now to FIGS. 1-6 by way of example, and not limitation, therein are illustrated example embodiments of solid separator 131 for solid-state lithium-ion batteries in addition to high energy density lithium solid-state anode 111 for solid-state battery 100. Solid-state battery 100, liquid electrolyte battery 200, and battery 300 may be referred herein as simply the “battery”. Solid separator 131 for solid-state lithium-ion batteries and porous separator 231 may be referred herein as simply the “separator”. High energy density lithium metal-based solid-state anode 111, liquid electrolyte anode 211, and anode 311 may be referred herein as simply the “anode”. While variations in construction, design, composition, chemistry, and assembly may be relevant to cathode 312, for the sake of clarity and consistency across FIGS. 1-6, any reference to cathode 312 is simply the “cathode”, and other relevant features may be referred to in a description as it relates to solid-state battery 100, liquid electrolyte battery 200, and battery 300. Alternatively, either of the anode or the cathode may simply be referred to as the “electrode” as may be understood to those of ordinary skill in the art. Solid-state battery 100, liquid electrolyte battery 200, and battery 300 may be charged via charger 351 and may discharge into powered device 352. As described herein, solid-state battery 100, liquid electrolyte battery 200, and battery 300 may each have a single cell or may have multiple cells connected and/or assembled in multiple layers of anode 311, cathode 312, and separator 331. Lithium, lithium metal, elemental lithium, and lithium-ions may be referred to interchangeably herein, and the disclosure is not so limited to a battery having lithium metal as its electrical flow element. Other elements may include but are not limited to zinc, sodium, cobalt, nickel, lead, potassium, other metals, salts thereof, the like and/or combinations thereof.

In one possibly preferred exemplary embodiment, solid-state battery 100 may include the following components: solid-state anode 111 having solid electrolyte 112 with fiber framework and shown with metal ion deposit 120, solid separator 131, and cathode 312 having solid-state cathode current collector 132. In an embodiment of liquid electrolyte battery 200, liquid electrolyte battery 200 may include the following components: liquid electrolyte anode 211 having graphite anode active material 212 and anode current collector 233, porous separator 231, and cathode 312 having liquid electrolyte cathode current collector 232. In an embodiment of battery 300, battery 300 may include the following components and connections: anode 311, cathode 312, separator 331, charger 351, and powered device 352.

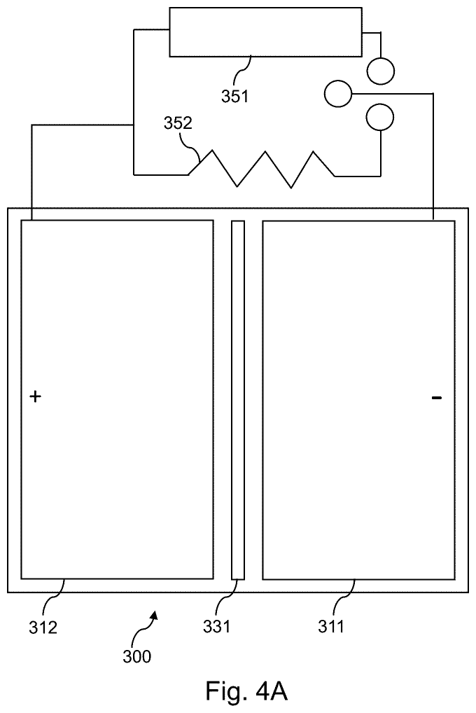

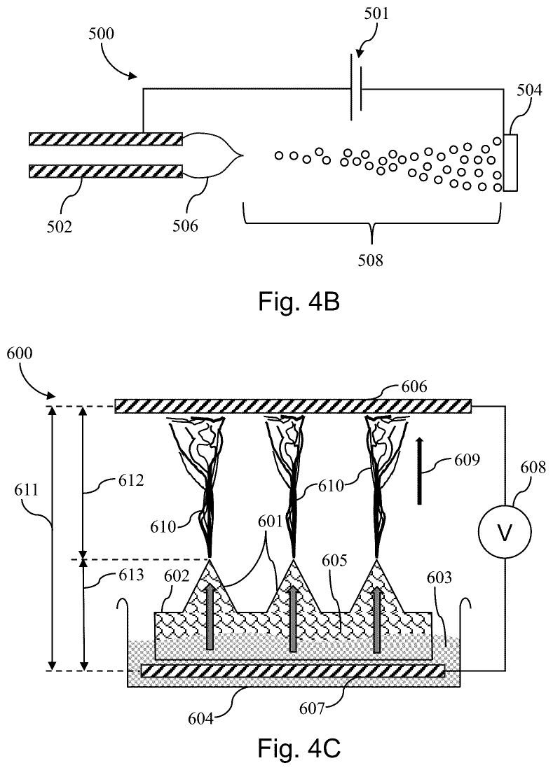

Referring now more specifically to FIG. 1, illustrated therein is an example of solid-state battery 100. Starting toward the top is solid-state anode 111 having solid separator 131 both above and beneath solid-state anode 111. Solid-state anode 111 may be formed from one or more layers of solid electrolyte 112, of which each layer of solid electrolyte 112 may be formed from a fiber framework. Generally, solid-state anode 111 may be understood as the negative or reducing electrode that releases electrons to the external circuit (see FIG. 4A) and oxidizes during an electrochemical reaction. Cathode 312 may be understood as the positive or oxidizing electrode that acquires electrons from the external circuit (see FIG. 4A) and is reduced during the electrochemical reaction. In this possibly preferred embodiment, solid-state anode 111 may be comprised solid electrolyte 112, which can be understood as a framework of interconnected fibers. The framework interconnected fibers therein solid-state anode 111 may have a variety of properties and may be either flexible or rigid. In the case of a ceramic fiber framework, ceramic may be utilized by doping to provide structure, support to solid-state anode 111 and solid-state battery 100, as well as a surface upon which lithium, or other metals, may deposit. Lithium metal at metal ion deposit 120 may provide the electronic conductivity for solid-state battery 100 while the solid composite framework/skeleton may provide volumetric support, surface layer for metal ion deposit 120 and lithium-ion conductivity. During charge and discharge of solid-state battery 100, metal ion deposit 120 may grow in size toward solid separator 131 or shrink toward center of solid-state anode 111. One means to combine, manufacture, and/or operably engage metal ion deposit 120 with the fiber framework of solid electrolyte 112 may be through the melt infusion of lithium metal into a treated composite framework. Initially, only a smally quantity of lithium metal may be needed to be infused into the pre-cell assembly of solid-state anode 111. In such a case where only a small quantity is infused into the pre-cell assembly of solid-state anode 111, most or even all reversible lithium which gives a cell its capacity may instead come from cathode 312 in the final assembly. Accordingly, during a first charge and during all subsequent charges of solid-state battery 100, metal ion deposit 120 may be detected or observed to be very small at or approximate the center of solid-state anode 111. During the charging process of solid-state battery 100, metal ion deposit 120 may be detected or observed to grow in size outward toward solid separator 131, even growing to occupy all space within the fiber framework of solid-state anode 111 along solid electrolyte 112. The deposit of lithium and/or other metals may further occur through temporary use of high voltage insertion cathodes such as lithium ferrophosphate (LFP), lithium cobalt oxide (LCO), nickel/manganese/cobalt (NMC), the like and/or combinations thereof varieties of cathodes. The higher surface area of solid electrolyte 112 having a ceramic fiber framework may allow for higher rates of operation (plating/stripping of lithium) of solid-state battery 100 if compared to a flat lithium foil. However, a flat lithium foil may also be used as an initial form of metal ion deposit 120 and may also be melt infused along center of solid-state anode 111 within solid electrolyte 112.

From the point of view of energy density, an important requirement for ceramic fiber frameworks of solid electrolyte 112 may be the use of low-density ceramic. A proposed example low-density lightweight ceramic may be Li₁₊ₓ AlₓTi₂₋ₓ P₃O₁₂ (LATP). In this embodiment of solid-state anode 111 having solid electrolyte 112 comprising ceramic, there may be additional components, methods of manufacture, and further variation that include various benefits and tradeoffs. These may include choice in active material and type of functional material processing. In a potentially preferred embodiment of a ceramic version of solid electrolyte 112, coating materials having qualities which attract particular metals may provide increased benefits to encourage smooth, consistent plating along the internal fiber framework. These may include engineering solid-state anode 111 having solid electrolyte 112 to measure approximately 80-90 μm in total per-layer thickness, approximately 5 cm×5 cm total length and width along solid separator 131, with porosity of internal fiber framework of percentages greater than 70%, having individual and/or average fiber diameters of less than 0.35 μm, having individual and/or average fiber lengths of greater than 1 mm, having a coating thickness of approximately 10 nm, and having coating material comprising oxides, nitrides, polymers, or ceramics. Oxide coating materials for fibers within solid electrolyte 112, by way of example and not limitation, include niobium, Al₂O₃+ZnO (AZO), aluminum, indium, zinc, bismuth, magnesium, silicon, gold, iodine, and sulfur oxides, the like and/or combinations thereof, each of which may be these metals in their oxide compound form. Nitride coating materials for fibers within solid electrolyte 112, by way of example and not limitation include boron, vanadium nitrides, the like and combinations thereof. Polymer coating materials for fibers within solid electrolyte 112, by way of example and not limitation include succinonitrile (SCN). Ceramic coating materials for fibers within solid electrolyte 112, by way of example and not limitation include closoborates (CB), lithium phosphorus oxynitride (LiPON), the like, and/or combinations thereof. By using one or more coatings to a ceramic fiber structure of solid electrolyte 112, ceramics which may not bind readily to lithium, or other metals, may be encouraged to bind to lithium, thereby acting as an electrolyte upon which solid metals, including lithium-ions, may freely move during charge and discharge.

In a second possibly preferred embodiment of the lithium conductor aspect of solid-state anode 111 for solid-state battery 100, a polymer framework in solid electrolyte 112 may be preferred. A polymer framework of solid electrolyte 112 within solid-state anode 111 may offer the added benefit of being flexible, where the previous ceramic rich fiber framework of solid electrolyte 112 within solid-state anode 111 may be described as rigid. This may offer various benefits and tradeoffs, both at the level of the individual cell or layer of solid-state battery 100, but also offer various tradeoffs and benefits to powered device 352, having there installed solid-state battery 100. Requirements of a polymer framework, and materials therein deposited, of solid-state anode 111 may be (a) having a melting point above the melting point of lithium metal (180 C), (b) non-conductivity of lithium-ions, and (c) infusion with lithium conductive material into the structure of solid electrolyte 112, such as other conductive polymers with the corresponding lithium salt (e.g., Lithium bis(trifluoromethanesulfonyl)imide/LiC₂F₆NO₄S₂/LiTFSI) or ceramic particles embedded into the polymer and/or upon its surface. In this embodiment of solid-state anode 111 having a polymer framework of solid electrolyte 112, there may be additional components, methods of manufacture, and further variation that include various benefits and tradeoffs. These may include a fiber mat which extends throughout solid-state anode 111 and solid electrolyte 112, which may further include aramids and polyimide frames. Furthermore, while not all coatings for ceramic fiber framework may be applicable to a polymer or polymer fiber framework, and while not all properties and features of a ceramic fiber framework may be directly applicable to a polymer or polymer fiber framework, some may. These may include engineering solid-state anode 111 having solid electrolyte 112 to measure approximately 80-90 μm in total per-layer thickness, approximately 5 cm×5 cm total length and width along solid separator 131, with porosity of internal fiber framework of percentages greater than 70%, having individual and/or average fiber diameters of less than 0.35 μm, having individual and/or average fiber lengths of greater than 1 mm, having a coating thickness of approximately 10 nm, and having coating material comprising oxides, nitrides, polymers, or ceramics. Oxide coating materials for fibers within solid electrolyte 112, by way of example and not limitation, include niobium, Al₂O₃+ZnO (AZO), aluminum, indium, zinc, bismuth, magnesium, silicon, gold, iodine, and sulfur oxides, the like and/or combinations thereof oxides. Nitride coating materials for fibers within solid electrolyte 112, by way of example and not limitation include boron, vanadium nitrides, the like and combinations thereof. Polymer coating materials for fibers within solid electrolyte 112, by way of example and not limitation include succinonitrile (SCN). Ceramic coating materials for fibers within solid electrolyte 112, by way of example and not limitation include closoborates (CB), lithium phosphorus oxynitride (UPON), the like, and/or combinations thereof. By using one or more coatings to a ceramic fiber structure of solid electrolyte 112, ceramics which may not bind readily to lithium, or other metals, may be encouraged to bind to lithium, thereby acting as an electrolyte upon which solid metals, including lithium-ions, may freely move during charge and discharge.

Included in a potentially preferred embodiment of either a ceramic fiber framework or a polymer fiber framework of solid-state anode 111 and solid electrolyte 112, initial deposits of lithium may be important for several reasons. These may be formed initially at metal ion deposit 120 in a very small, nearly insubstantial amount, but grow in size, weight, and volume, and even may occupy all empty space within solid-state anode 111 and solid electrolyte 112. This may be accomplished through various means, though a potentially preferred process to initially deposit metal near the center of solid-state anode 111 on the surface of solid electrolyte 112, and its fibers, may be through the melt infusion of lithium foil.

Additionally, the manufacture of the fibers themselves, whether ceramic or polymer, may offer a variety of important improvements to the structure, formation, and overall properties of solid electrolyte 112, solid-state anode 111 and solid-state battery 100. These techniques may have little to no known applications in the battery technology industry, but may have significant applications in the materials sciences and non-woven material industry. One such process may include sol-gel processes, which may preferably occur prior to deposit of metal ion deposit 120. In this chemical procedure, a “sol” (a colloidal solution) can be formed that then gradually evolves towards the formation of a gel-like diphasic system containing both a liquid phase and solid phase whose morphologies range from discrete particles to continuous polymer networks. In the case of the colloid, the volume fraction of particles may be so low that a significant amount of fluid may be required to be removed initially for the gel-like properties to be recognized. One such means of fluid removal may be to simply allow time for sedimentation to occur, and then pour off the remaining liquid. Centrifugation can also be used to accelerate the process of phase separation. Removal of the remaining liquid (solvent) phase requires a drying process and may result in a significant amount of shrinkage and densification. The rate at which the solvent can be removed is ultimately determined by the distribution of porosity in the gel. The ultimate microstructure of the final component can be strongly influenced by changes imposed upon the structural template during this phase of processing. A thermal treatment, or firing process, is often necessary in order to favor further polycondensation and enhance mechanical properties and structural stability via final sintering, densification, and grain growth. One of the distinct advantages of using this methodology as opposed to the more traditional processing techniques is that densification is often achieved at a much lower temperature. The precursor sol can be either deposited on a substrate to form a film (e.g., by dip-coating, spin coating, or electrospinning), cast into a suitable container with the desired shape (e.g., to obtain monolithic ceramics, glasses, fibers, membranes, aerogels), or used to synthesize powders (e.g., microspheres, nanospheres). This technique, in combination with electrospinning, is known to create a paper-like material having open cavities which may be highly suitable for the depositing of metals, namely lithium ions. Additional processes which may further enhance this space-filling and open cavity feature of solid electrolyte 112, using various compositions of the disclosed ceramics and polymers, may include co-precipitation, evaporation and self-assembly, and utilization of nano-particles.

In either a ceramic or polymer embodiment of solid electrolyte 112, the material by which the fibrous structure having open cavities, the fibrous structure having a lithiophilic coating, may be considered an active material, of which comprises solid-state anode 111. In other words, the active material of solid-state anode 111 may be solid electrolyte 112, which is the active material through which lithium-ions migrate, congregating at metal ion deposit 120. Whichever active material is manufactured in order to create solid-state anode 111 can be processed into a functional material having these properties and acting as solid electrolyte 112 of solid-state battery 100. A first stage in this process may be synthesis of a fiber mat including substances such as LATP, closoborates, and sulfide ceramics. Stages in the sol-gel, or other processes to form the open cavity structure of solid electrolyte 112, may be improved through lower the firing temperature required by implementation of aliovalent substitutions. Other improvements may include maximize density by using flux additives (e.g., Li₂O, MgO, ZnO, Li₃PO₄, Li₃BO₃, B₂O₃, LiBO₂, Al₂O₃, Ta, Nb, Y, Al, Si, Mg, Ca, YSZ, NiO, Fe₂O₃, the like, and/or combinations thereof). In order to achieve functional material processing of solid electrolyte 112, the active material of a pre-assembly solid electrolyte 112 may be required to obtain a rugged functional laminate, sheets or mats for use as solid-state anode 111. Slurry additives may be added in order to process a green laminate during the process of rapid sintering. These slurry additives may include, but are not limited to resins, oils, and dispersants (e.g., PAA, glucose, PVP, ethylene glycol, oleic acid, ultrasonic horn, the like and/or combinations thereof). Sintering of the green material using traditional techniques known to those skilled in the art can be a long process (>10 hours) and may need to occur at high temperatures (>1250° C.). These traditional requirements may require high costs of operation, difficulty in scaling up as well, and an undesired loss of lithium by evaporation during sintering. The loss of lithium at these times and temperatures may need to be counter measured by using extra lithium salts during synthesis, which only further increases cost. Instead, methods to allow for scalable application in open atmosphere and prevent the loss or consumption of lithium should be substituted. The resulting sintered green laminate should contain voids for lithium metal melt infusion, subsequent to sintering, which can then occur at room temperature. Voids can instead be built in by using sacrificial plastic/carbon beads or by electrospinning the into fiber mats, as described above. The resulting solid electrolyte 112 may then be suitable for deposit of lithium along metal ion deposit 120.

Alternative measures to encourage these properties in solid electrolyte 112, thereby creating an optimal solid-state anode 111, may include buy are not limited to reactive sintering of starting materials, sintering within an electric field, microwave sinter, SPS or spark plasma, cold sintering using solvent evaporation and salts CSP, and flash sintering using high currents. Alternatively, or in combination with these techniques of the development of solid electrolyte 112, porous sheets may be manufactured using sacrificial beads which are various plastics or carbons with low vaporization temperatures that can be removed and/or destroyed leaving openings in the fiber mat, or the development of a ceramic fiber mat through electrospinning. Other contemplated means which specifically apply to polymer fiber versions of solid electrolyte 112 include the use of polymers having melting points of lithium metal (180 C). These polymers, however, typically do not conduct lithium-ions so they, would serve a structural role upon which additional lithium conductive material may be infused into the structure such as other conductive polymers (with the corresponding lithium salt such as LiTFSI) or ceramic particles. For instance, by way of example and not limitation, fiber mat comprising polyimide (having melting point of 450° C.) may be used to infuse with melted lithium and serve as a coating. Further examples include aramids, polyimide frames. Yet another example of providing a suitable formation for solid electrolyte 112 may be a hybrid composite structure having both polymer fiber and ceramic fiber properties. A hybrid composite fiber mat could include fumed silica and G4/LiTFSA with boron/vanadium (or other nitrides) doping upon the surface.

Further important to the surface structure and composition of solid electrolyte 112 may be coating alternatives which may offer, either alone or in combination, additional benefits to the deposit, motility, and smooth plating of metal ion deposit 120. These may include CVD/PVD/PECVD and/or ALD vapor deposition in combination with AZO coating, use of I₂, Li₃N, Li₃PO₄, LLZO, Li₉AlSiO₈, Li₃OCl, LiI:₄CH₃OH, or use of metals which alloy well with lithium, including but not limited to aluminum, indium, zinc, magnesium, silicon, and/or gold. Solution coating may also be used upon, or form a critical component of, solid electrolyte 112, which may be developed using a sulfur-based solution coating method with solutions of, for example, polysulfides, dissolved sulfur ZnO doped argyrodite Li₆PS₅Br, Li₂S₃ or Li₃S₄ dissolved in DEGDME. Polymer coatings may additionally be employed as a surface coating to solid electrolyte 112, which may include SN/FEC with additives and salts (e.g., CsPF₆, CsTFSI, LiNO₃, LiF, CuF₂), elastomers such as SHP, and even glues such as polydopamine and/or polysiloxanes. These various coatings to solid electrolyte 112 may offer various benefits, including reduction in dendritic growth of lithium during plating at metal ion deposit 120 and on solid electrolyte 112, extending possible range of choices for solid electrolyte 112 composition for various applications, and prevention of reaction between various highly useful materials for construction of solid-state anode 111 and lithium, or other, metals.

Alternatively, it is contemplated herein that metal ion deposit 120 may be replaced by an anode current collector placed therein solid-state anode 111 within solid electrolyte 112. These may include foils or coatings upon which metals, specifically lithium, may be deposited. Exemplary materials for an anode current collector placed therein solid-state anode 111 within solid electrolyte 112 may include but are not limited to vanadium nitride, lithium-aluminum alloy(s), liquid metals including gallium, indium, and tin, the like, and/or combinations thereof.

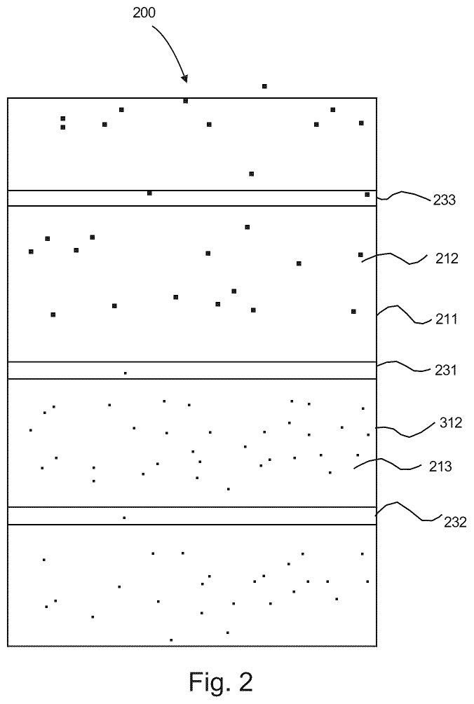

Referring now specifically to FIG. 2, illustrated therein is an example of a sectional view of a cell of liquid electrolyte battery 200. Generally, a traditional lithium-ion battery, as liquid electrolyte battery 200 may include liquid electrolyte anode 211 having graphite anode active material 212 and anode current collector 233, porous separator 231, and cathode 312 having liquid electrolyte cathode current collector 232. Known variations of lithium-ion batteries having liquid electrolytes may achieve 275 Wh/kg capacities and feature the ability to recharge, but have the serious shortcomings covered in the Background section above.

If sufficient open space is achieved while maintaining structure, lithium smooth plating, as well as other considerations herein described, solid-state battery 100 may achieve substantially higher energy density while allowing for additional benefits such as durability, safety, quick charging, as well as other above-mentioned benefits. For instance, the 275 Wh/kg energy density of liquid electrolyte battery 200 can be compared to solid-state battery 100 of the disclosure, which has in various forms and combinations, achieved upwards of 635 Wh/kg.

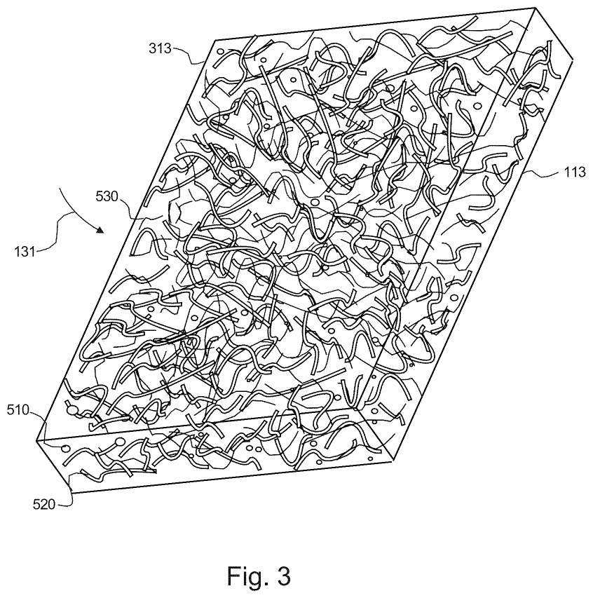

Having thus described a variety of exemplary and suitable solid-state anode for a solid-state lithium-ion battery, referring now specifically to FIG. 3, illustrated therein is a perspective view of a section of an exemplary embodiment of solid separator 131 for solid-state lithium-ion batteries. Broadly described, solid separator 131 for solid state lithium-ion batteries may be formed in one or more sheets, each sheet having a microscopic structure featuring the various improvements and features described herein. These may include, but are not limited to main polymer 520 (illustrated as the thicker of the two groups of long fibers throughout solid separator 131), structural polymer 530 (illustrated as the thinner of the two groups of long fibers throughout solid separator 131), and reinforcing additive 510 (illustrated as a group of circles throughout solid separator 131). It should be understood that, while each side of solid separator 131 may have unique or distinct features, qualities, chemical compositions, the like, and/or combinations thereof, top side 313 and bottom side 113 may be thought of as having indistinct characteristics for the purposes of this disclosure. That being said, should top side 313 operably engage with cathode 312, bottom side 113 would operably engage with anode 311 (or liquid electrolyte anode 211). That is not to say that bottom side 113 could operably engage with cathode 312, or that top side 313 with anode 311, but simply that an anode would reside opposite solid separator 131 the cathode, or across therefrom. While not drawn to scale nor drawn to explicitly portray the microscopic appearance or structure of solid separator 131, FIG. 3 portrays an exemplary illustration in order to further demonstrate the purpose, structure, and formation of solid separator 131. Furthermore, those skilled in the art will appreciate the cross-sectional nature of the illustration of FIG. 3 and understand it may represent a small fraction of the material which may be required for even a single-cell solid-state lithium-ion battery. The thickness of solid separator 131 may be understood to be generally uniform, but at a microscopic level, gradations of thickness may be apparent. Solid separator 131 may be understood to be very thin, having a high surface area, and low density. Other objective qualities of solid separator 131 are understood and described herein.

Turning now to the basic structural and chemical constituent composition of solid separator 131, as illustrated in FIG. 3, main polymer 520, structural polymer 530, and reinforcing additive 510 are herein described. Main polymer 520, as illustrated in FIG. 3, may be duplicated across length, width, and depth of solid separator 131 and may be understood to be generally and/or evenly distributed throughout solid separator 131.

As explained above, traditional lithium conductive polymer electrolytes may be polyethylene oxide (PEO) based. This family of electrolytes requires temperatures above 45° C. to provide conductivities above 0.1 mS/cm, typically around 60° C. A wider range of temperatures offering similar conductivities is necessary for adequate industry adoption. PEO is the polymerized version of ether solvents which are known to conduct lithium ions. Ether solvents are not used in liquid cells because their low polarity results in low conductivity for lithium-ions. In other words, PEO polymers inherit the drawback of their monomer constituents. However, carbonate solvents have a higher polarity than ether solvents and generally provide higher conductivity for lithium ions. Carbonate solvents also have improved oxidative stability due to the delocalization of free electrons over the carbonyl group. It is thus desirable to employ polymers from carbonate solvent monomers in main polymer 520 to enable solid separator to conduct lithium ions while improving oxidative stability. Vinylene carbonate, ethylene carbonate or propylene carbonate each provide suitable monomers for a respective polymer, as do combinations of these carbonates as monomers in sequence of a carbonate polymer. Additionally, due to the property allowing for delocalization of electrons, an exemplary solid separator 131 comprising polymers derived from carbonates can offer the additional benefit of increasing the allowable voltage of cathode 312, beyond that which may otherwise be possible with PEO based separators. Carbonates may be polymerized through a variety of chemical reactions, such as the exemplary chemical reaction of polymerizing the alkene bond in the solvent via free radical polymerization.

Certain various exemplary polymers for main polymer 520 are herein described, each of which may be used in solid separator 131, either alone or in combination. Important to each candidate polymer for main polymer 520 is the concept of a spacer monomer. Vinylene carbonate (VC) has the highest conductivity for lithium ions, and is therefore an important candidate block material for main polymer 520. However, due to its ring structure it is highly rigid when polymerized, making the lithium conductivity of a resulting vinylene carbonate polymer very low. To increase its chain mobility and ultimately its lithium-ion conductivity, a (series of) “spacer” linear monomers may be inserted in between the bulky VC ring monomers. Such “spacer” linear monomers may be diol acrylates (e.g., butane diol and hexane diol) or glycol acrylates (e.g., triacrylates, diacrylates and monoacrylates). Since solubility of combinations of these molecules in solution may be challenging, solubility of these materials may be improved by a small mole ratio of highly polar epoxy oxirane (e.g., glycidyl acrylate). Oxiranes can be polymerized with low boiling point amines post assembly, in untreated atmospheric air, to increase the separator strength. Removal of excess unpolymerized initiators or polymerization reactants such as azobisisobutyronitrile (AIBN) or amines may be important to maximize cycle life and improve battery operation. Left unremoved, these highly reactive materials may accelerate battery deterioration. It is thus important that a polymerization mechanism is used to strengthen the separator with low boiling point reactants such that any excess can be evaporated easily during drying steps. In summary, this polymer candidate, in its basic trimer constituent, may be understood as spacer+VC+oxirane.

Other such polymer candidates for main polymer 520 may be understood, in their basic trimer constituents as: spacer+prop-1-ene1,3-sultone (PES)+oxirane, spacer+4-vinyl-1,3-dioxolan-2-one+oxirane, spacer+allyl methyl carbonate+oxirane, and polyacrylonitrile (PAN)+succinonitrile (SCN). Specifically, succinonitrile (SCN) may be an important additive to main polymer 520 due to its properties as a highly conductive wax for lithium ions in its polymer state. SCN may be added in various ratios to the solid separator 131 to improve its conductivity as needed. For example, the low conductivity of PAN may be enhanced by a small ratio of SCN.

Structural polymer 530, as illustrated in FIG. 3, may be duplicated across length, width, and depth of solid separator 131 and may be understood to be generally and/or evenly distributed throughout solid separator 131. Properties perhaps most important or even critical to solid separator 131 are (i) lithium conductivity and (ii) electron insulation. An additional property which may be thought of as beneficial, though not critical, may be a low material density which may be required to yield cells with high energy density. As stated above, the lowest density solid materials are polymers, making lithium conductive polymers an excellent candidate for solid separator 131 in order to provide both a backbone of a solid-state cell and lend it the property of high energy density. Lithium conductivity in a polymer is given by Li+ coordinating sites which have high mobility. Such groups may include ethereal oxygens, carbonate oxygens or silicon-based polymers with similar functionalities such as siloxanes. Other Li+ conductive sites on a polymer may be nitrogen-, phosphorous-, or sulfur-based such as those found in polydopamines, polyimides, polyphosphazenes, or polysulfonates. Preferably, the overall thickness of solid separator 131 should be less than 20 microns in thickness. Solid separator 131 should also be free standing and stable in humid air. These requirements would, in addition to benefiting the overall utility and functionality of solid separator 131, may facilitate adoption of solid separator 131, and solid-state batteries in general, by battery manufacturers across various markets. Polymers having high lithium conductivity generally have short chains so they may not form thin, free standing films on their own. Their strength modulus may be improved by creating composites via mixing with inorganic materials, such as reinforcing additive 510. It is desirable that, in addition to main polymer 520 and structural polymer 530, these inorganic materials which may comprise reinforcing additive 510 are also lithium conductive and with low density. Such inorganic additives that may comprise reinforcing additive 510 may be LATP, LLZO, LSPSCl, LGPS, lithium conductive halides, closo-/nido-borates, SiO₂, TiO₂, ZnO, Fe₂O₃, Ga₂O₃, BN, GAN, VN, the like and/or combinations thereof. Electronic insulating carbon-based additives may also be used to form reinforcing additive 510. It may be important that, whether inorganic or carbon-based, reinforcing additive 510 remain as a small fraction of the composite while remaining useful for its reinforcing purpose. An exemplary amount for reinforcing additive 510 may be <10%.

The method of combination of main polymer 520, structural polymer 530, and reinforcing additive 510, or any two of those in combination, may be important to influencing the overall utility, structure, function, and use of solid separator 131. An exemplary method of combination of main polymer 520, structural polymer 530, and reinforcing additive 510 may be electrospinning. This may be understood as a method of combining polymers and inorganic materials into composites, or forming polymer/inorganic composites. Furthermore, production of solid separator 131 via electrospinning and/or sintering the inorganic component into the polymer component may be understood to produce a highly porous mat (i.e., a fibrous mat having >90% porosity), which may then be infused with a conductive polymer. Those skilled in the art of non-woven materials manufacturing may appreciate that laboratory-scale electrospinning may commonly be performed through application of high voltages between a metallic syringe needle and a conductive plate. Electrospinning may be a more adaptable fiber spinning technique than traditional melt spinning. Electrospinning can be performed via a room temperature process and can yield randomly aligned fiber mats or well-aligned fiber mats, depending on desired mat structure. The resultant fiber mat produced via this process can then remain exposed to ambient air while remaining non-reactive at room temperature. If the needle electrospinning method is used, hollow-core fibers may even be obtained by using co-axial needles. This approach can even further reduce the weight of solid separator 131. Unfortunately, no known methods of scaling this well-known laboratory procedure currently exist, at least with respect to scaling such methods including polymer binding agents, polymer fibers, ceramic additives, and salts in combination to obtain fibers and/or fibrous mats. However, viscoloids can be modified to spin fibers under a voltage via rotating conductive spirals without the use of needles, following the same principle. Using viscoloids, modified to spin fibers under a voltage via rotating conductive spirals without the use of needles may be a scalable process. Exemplary materials which can be electrospun into fibers under these conditions include, but are not limited to, LATP, LLZO (inorganic), PI (polyimide—organic polymer), carbons (organic), aramids (polymers), the like and/or combinations thereof. Utilization of the modified viscoloid technique using these exemplary materials may be important to scalable production of electrospun of main polymer 520, structural polymer 530, and reinforcing additive 510, or any two of those in combination, to form solid separator 131 in a solid porous mat.

The method of combination of main polymer 520, structural polymer 530, and reinforcing additive 510, or any two of those in combination, may also include blade casting to form solid separator 131. By blade casting polymer, inorganic, and/or lithium salt mixtures, one skilled in the art may form a sturdy, porous, fibrous mat with the lightweight properties described herein, suitable as solid separator 131. Blade casting has the further benefit of being an already scalable process, one which is also already a traditional process known in the battery industry. For instance, virtually all battery electrodes may be assembled by this technique. The blade casting method of this mixture may provide more benefit within solid separator 131 which comprise polymer blends to achieve desired strengths at required thicknesses. However, it may be challenging to obtain large area solid separator 131 having a thin (<20 micron) structure if a majority constituent composition of solid separator 131 is polymer composition, if said polymer composition is also free standing. This method may instead be more suitable for a complete layering cell assembly procedure where solid separator 131 is layered on top of electrodes in a top-to-bottom full inhouse multi-cell battery assembly. In this case, since assembly can occur concurrently with manufacture of solid separator 131, there is no need for the free-standing requirement described above. Some materials which can be used as components for a blade cast slurry to manufacture solid separator 131 include but are not limited to: fumed silica (inorganic additive)+G4 (tetraglyme, solvent) and/or LiTFSA (Li salt), LiBOB, LiTFSI, LiBF2(C2O4), LiBF2(C2O4), C2O4Li2, CF3CO2Li, C6H5COOLi, other lithium salts, the like, and/or combinations thereof.

In addition to the combination of main polymer 520, structural polymer 530, and reinforcing additive 510, or any two of those in combination, via electrospinning or blade casting, to form solid separator 131, it may be further important to provide interface coatings (or interfacing coatings) at an interface with anode 311 or cathode 312 to make possible and/or improve solid-state battery 100. Since it may be desirable to maximize lithium conductivity across a thin (<20 micron) solid separator 131, additional treatment to top side 313 and/or bottom side 113 of solid separator 131 may be required in order to enable anode 311 and cathode 312 to reside at such close proximity, even in the presence of solid separator 131. In other words, the interface between anode 311 and/or cathode 312 and solid separator 131 may require additional treatment to ensure long term operation, durability, and sustainability of solid-state battery 100. This may be a serious issue especially at the interface with exposed lithium metal of solid-state anode 111. Interface coatings may generally be applied, formed, or otherwise reside at top side 313 and/or bottom side 113. Exemplary coatings which may stabilize and promote this interface include but are not limited to graphites/graphenes (i.e., carbons), nitrides/borates (e.g., boron nitrides, MgB₂, Cu₃N), metal alloys (e.g., Al coating from AlX₃ or Al(NO₃)₃ salts dissolved in solutions, In coating from In(TFSI)₃, InF₃, In(NO₃)₃ or salts dissolved in solutions thereof), Sulfur (e.g., Li₂S+S, LPS), or FEC (i.e., fluoroethylene carbonate, a cathode stabilizer additive).

Turning now specifically to FIG. 4A, illustrated therein is a simple block diagram for battery 300 having anode 311, cathode 312, separator 331, charger 351, and powered device 352. When cathode 312 is in conductive contact with charger 351, a circuit is formed with anode 311, thereby charging battery 300. Alternatively, when cathode 312 is in conductive contact with powered device 352, a circuit is formed with anode 311 and powered device 352 is powered. Each of charging and powering occur through any form of known electrochemical processes between anode 311 and cathode 312. In addition to various features, components, methods of manufacture, and improvements to solid-state anode 111 of solid-state battery 100 as herein described, the parts and features of battery 300 may be required to fully manufacture and use solid-state battery 100. Furthermore, various improvements to the parts of battery 300, as known and developed in the art of battery manufacture, including solid-state battery 100 manufacture, may further increase the benefits as herein described of solid-state anode 111. A mere substitution of solid-state anode 111 for anode 311 may not suffice, and one skilled in the art of battery design and manufacture may implement and adapt the features of solid-state anode 111 into battery 300 so as to fully take advantage of the disclosure herein.

Turning now to FIG. 4B, a schematic of electrospray system 500 as it may relate to the manufacturing techniques of the disclosed battery components and methods of manufacture. As may be appreciated by those having ordinary skill in the art, the schematic provided herein FIG. 4B, as may be true with the battery schematic of FIG. 4A, may be highly simplified for illustration purposes only and those skilled in the art may understand that highly technical machines, computer-assisted technologies, and other components may be involved in the sophisticated machinery involved with the actual manufacture of the battery components as herein described. Then, as it relates to such machinery's operation, an electrospray may be produced when a sufficient electrical potential difference 501 is applied between a conductive or partly conductive fluid exiting a capillary orifice and an electrode so as to generate a concentration of electric field lines emanating from the tip or end of a capillary 502 of an electrospray device. When the repulsion force of the solvated ions exceeds the surface tension of the fluid sample being electrosprayed, a volume of the fluid sample is pulled into the shape of a cone, known as a Taylor cone 506 which extends from the tip of the capillary. Small charged droplets 508 are formed from the tip of the Taylor cone 506 and are drawn toward the extracting electrode 504. The physical size of the capillary determines the density of electric field lines necessary to induce electrospray. Controlling such ionization via adjustments to various parameters, including but not limited to electrical potential difference 501, size/shape/quality/material of extracting electrode 504, size of capillary 502, and distance between the latter thereof, may be critical to the formation of various deposits, fibers, and films of the disclosure, as may be further described below.

FIG. 4C illustrates a simplified exemplary embodiment of electrospinning system 600 that includes an electrospinning structure having porous elements 601 formed on common porous base 602 that may be partially immersed in a bath of electrospinning fluid 603 contained in vessel 604. Depending upon the degree of immersion, the affixed ends of elements 601 themselves may or may not reside below the nominal level of the electrospinning fluid 603, though, flow 605 of electrospinning fluid 603 that may be enabled by capillary action may permit fluid 603 to substantially impregnate the array of elements 601 and base 602, even when fluid 603 is not electrically stressed. First electrode 606, the counter-electrode, is situated at a first distance from the free ends of the elements, while second electrode 607 is disposed in the bath of electrospinning fluid at a second distance from base 602. Power supply 608 may electrically connect electrodes 606 and 607 such that a difference in electrical potential can be established. This potential can be held predominantly in either polarity or it can periodically vary from one polarity to the other. For example, a sinusoidal wave centered about the electrical reference potential, e.g. “ground”, may be utilized in some embodiments. In either case, a magnitude of the potential can also be periodically modulated so as to prevent problematic depletion of the “fluid charges” that occupy the elements and their bases. During use of the system illustrated in FIG. 4C, a difference in electrical potential can establish electric field 609 in region 611 therebetween electrodes 606-607, including sub-region 612 between the free ends of elements 601 and counter-electrode 606 and sub-region 603 between the free ends of elements 601 and electrode 607. The quotient of the modulus of the difference in potential and the distance between the two electrodes may be understood as a first approximation to the magnitude of this field. However, a measure of spatial non-uniformity typically occurs such that the field is specifically amplified local to the free ends of the elements 601. In general, this amplification may depend upon factors that include, but are not be limited to, the geometry of the free ends, the material composing the elements, the material composing the bases, the electrical properties of the electrospinning fluid, and the relative spacings 611, 612, and 613 of the electrodes, or combinations thereof. When the strength of the electric field in the vicinity of the free ends of elements 601 is sufficiently large, electrohydrodynamic jetting can occur, which may be relevantly described as a splaying of jet 610. So long as the rheological properties of electrospinning fluid 603 are appropriate, this jetting will result in the production of continuous filaments or fibers 610 (or jet 610) that propagate away from the elements and are eventually intercepted and collected by counter-electrode 606. In the context of electrospinning, **splaying** refers to the phenomenon where a single jet of polymer solution, ejected from the spinneret (needle or nozzle) under a high electric field, splits or diverges into multiple smaller jets or filaments. This occurs due to the interplay of electrostatic forces, surface tension, and the viscoelastic properties of the polymer solution.

Then, as it relates to the splaying of jet 610 which may occur via the processes and machinery described in relation to electrospinning, and as it relates to machinery illustrated therein FIG. 4C as may be understood by those having ordinary skill in the art, during the electrospinning of a polymer solution, lithium salt solution, and/or slurry thereof, first, a high voltage may be applied to a polymer solution contained therein electrospinning system 600, forming a Taylor cone at the spinneret tip (e.g., elements 601), and further increasing its charge density. When the electric field overcomes the solution's (or slurry as may be relevant herein) surface tension, single jet 610 may be ejected from one or more of elements 601. Then, instability and splitting may occur as jet 610 travels toward the counter-electrode 606, which may be grounded and serve as a collector. Such instability and/or splitting of jet 610 may cause it to undergo whipping or bending instabilities due to charge repulsion within the jet. At a certain point, jet 610 may then “splay” or split into multiple smaller jets or sub-filaments, as may be understood by those having ordinary skill in the art. As may be further understood by those having ordinary skill in the art, such splitting may also be driven by the Coulombic repulsion between charged segments of jet 610, combined with solvent evaporation, which may in turn reduce the diameter thereof jet 610, and further increasing its charge density. Other viscoelastic properties of the solution (or slurry) can also influence how and when splaying of jet 610 occurs, thereby having an effect on the fibrous mat formed thereon counter-electrode 606 (i.e., collector 606). It can therefore be said that this splaying may contribute to the formation and conformational shape/pattern of finer nanofibers, as the division into smaller jets reduces the diameter of the resulting fibers and the pattern which they may form at collector 606. A key property of splaying of fibers during electrospinning may be the chaotic motion which may be observed in electrospinning, generally, which while it may make it challenging to precisely control fiber deposition, it may be beneficial for producing nonwoven mats with high surface area. Then as it relates to the formation of electrodes for solid-state lithium-ion batteries and polymers thereof, such chaotic spinning when performed on the chemical formulations as are herein described, and specifically those lithium salt solutions and ceramic slurries, such manufacturing techniques when performed in combination with electrospinning and electrospraying, which may be especially true in a hybrid manufacturing process, may offer vast benefits over currently available techniques to create intricate microscopic areas for the deposition of lithium ions, which may be conducted in electrodes and batteries thereof.

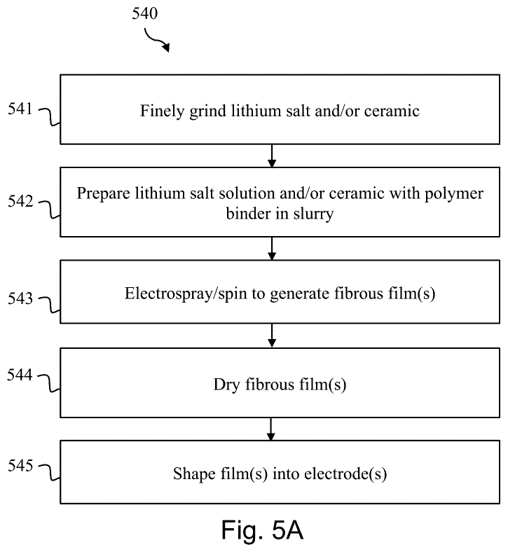

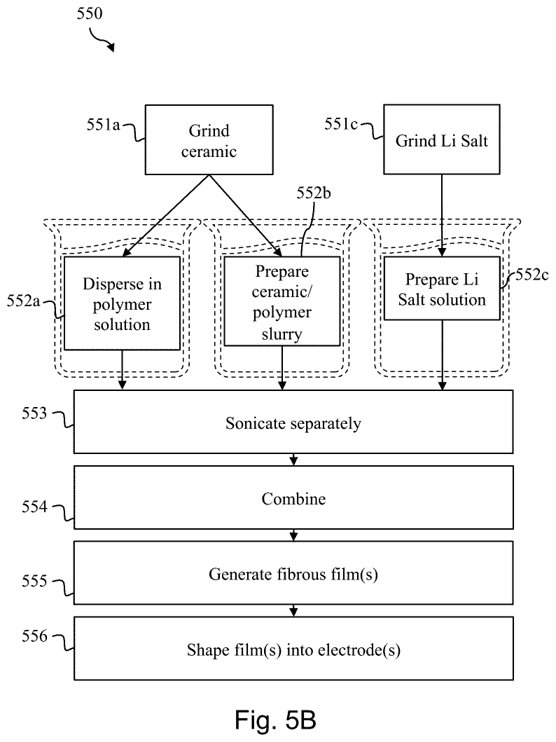

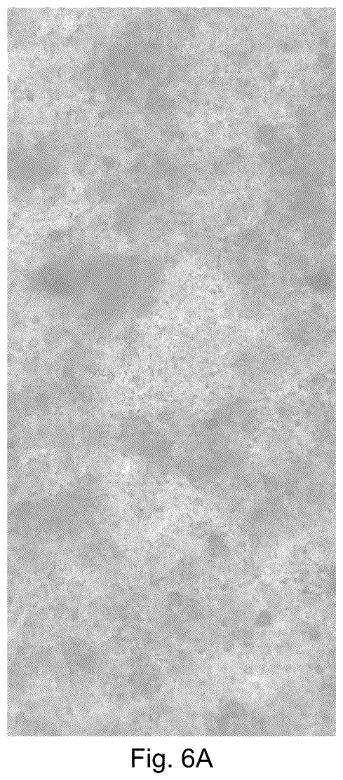

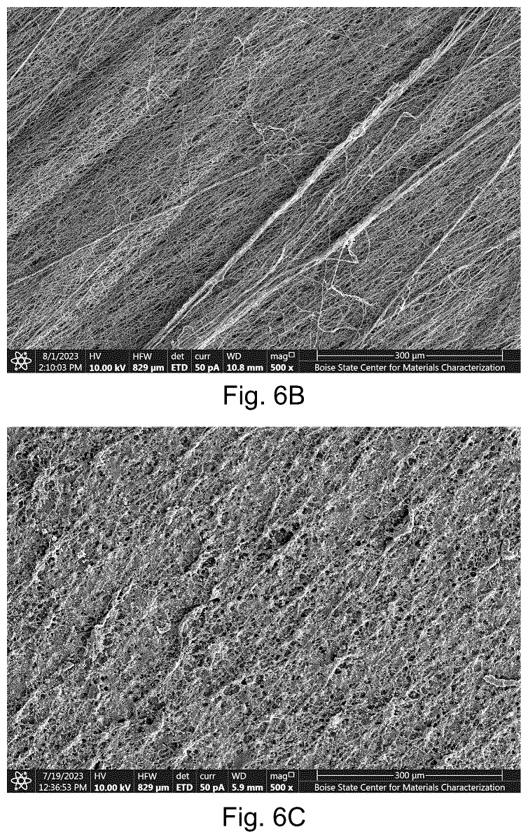

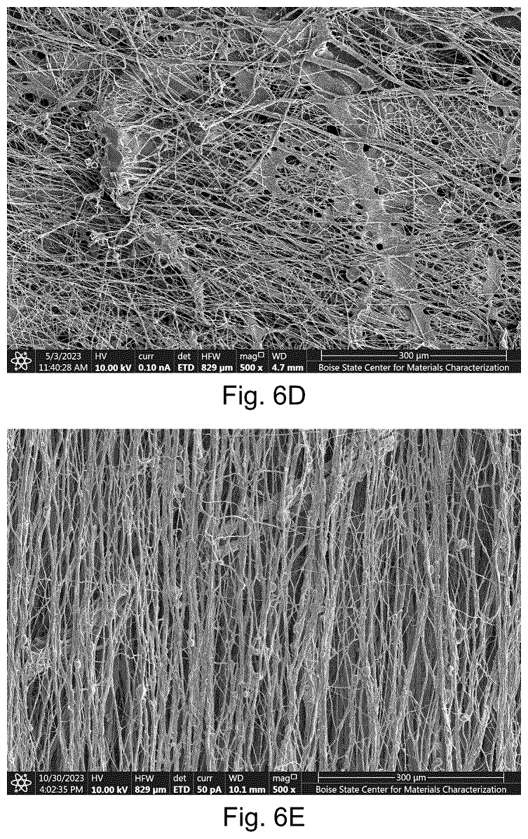

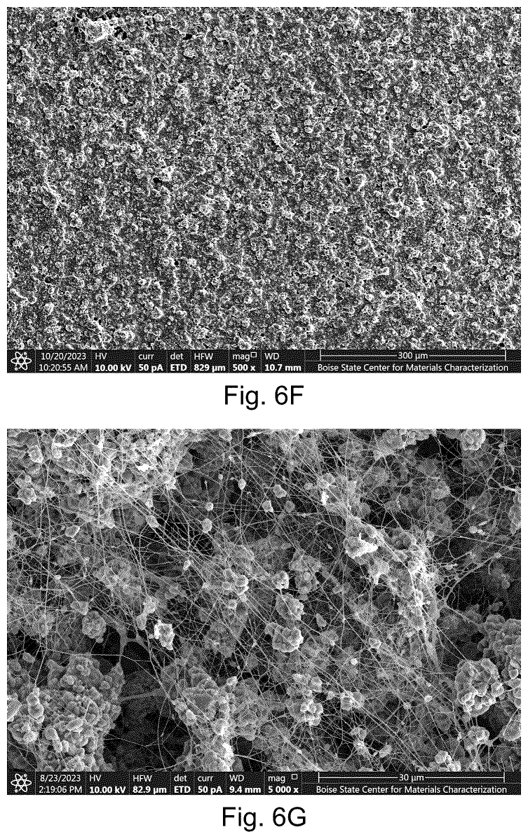

Turning to FIG. 5A, illustrated therein is a simplified method flowchart of first exemplary manufacturing method 540 of the disclosure, which is specified herein via specific, non-limiting exemplary formulations thereof. As may be realized herein by those having ordinary skill in the art, method 540 may be understood to provide a series of methods and formulations for producing lithium-ion battery electrodes via electrospraying, electrospinning, or hybrid approaches thereof. First, solutions and/or slurries of, by way of example and not limitation, lithium salts and ceramics, namely, Lithium bis(trifluoromethane)sulfonimide (LiTFSI) and Lithium Aluminum Titanium Phosphate (LATP), respectively, may be ground into a fine powder at step 541. Then, an amount thereof, e.g., 27 g of LATP, may be measured and introduced into an amount of solvent, e.g., 134 ml of water, and become subject to continuous stirring and/or subsequent sonication for an amount of time (e.g., 5 minutes) at step 542. An additional component of step 542 in some exemplary embodiments of method 540 may be introduction of a polymer (e.g., Polyethylene Oxide (PE)), again under continuous stirring and/or subsequent sonication for an amount of time (e.g., 6 minutes). Then, as described in relation to FIGS. 4B-C, electrospinning and/or electrospraying may be performed at step 543, and in one example by way of illustration and not limitation, voltage may be set on electrospinning machine 600 to 25 kV, subregion 612 may be set to 80 mm, and elements 601 having relatively wide openings may be used to accommodate the viscosity of such electrospinning slurry 603. Additionally, in such exemplary formulations, the flow rate thereof may be adjusted to 5 ml/min for induction and/or manufacture of consistent fiber morphology. Then, at step 544, the resulting deposit thereon collector 606, which may be grounded and composed and/or covered in a high-grade aluminum foil, may be obtained therefrom collector 606 and dried in conditions and a timeframe sufficient (e.g., at 60° C. for 2 hours) to form a fibrous mat and/or film. Finally, at step 545, electrodes may be shaped from such fibrous mat and/or film, by, e.g., punching 20 mm diameter circular disks and resultingly assembled into coin cells between stainless-steel electrodes. Then, the resulting battery may be subject to other final manufacturing steps and sold/used, and/or be subject to testing for experimental and/or quality control purposes. Other proposed and more detailed methods are herein disclosed as they may be relevant to those having ordinary skill in the art in the remaining written description and as it may relate to FIGS. 5B and 6A-G.

Turning now to FIG. 5B, illustrated therein is a schematic of representative method 550 for preparing and processing a ceramic (e.g., lithium aluminum titanium phosphate (LATP)), a lithium salt (e.g., lithium bis(trifluoromethanesulfonyl)imide (LiTFSI)) and a polymer in a solvent (e.g., N-methyl-2-pyrrolidone (NMP)) to generate fibrous films suitable for electrode fabrication. Beginning at step 551a, a ceramic is ground to a fine powder. A portion of this ground ceramic is then dispersed in a solution containing, e.g., 12% polymer (e.g. NMP solvent with 12% by weight polymer therein the solution) (step 552a) and further formulated into a ceramic and polymer slurry thereof (step 552b). In parallel, the lithium salt is ground (step 551c) and prepared as a separate solution (step 552c). Each of these mixtures is subjected to separate sonication (step 553) to ensure complete dissolution of solute(s) into solvent(s) as well as dispersment and uniform dispersion of the solids thereof the slurry. Subsequently, at step 554, the slurry are carefully combined and left to age, facilitating further homogenization. The resulting mixture is then used to generate fibrous film(s) (step 555) via electrospinning at a voltage of 30 kV, a target distance of 80 mm, and a feed rate of 10 ml/min. Finally, in step 556, the fibrous film(s) are shaped into electrodes-typically by drying, calendering, and cutting to the desired dimensions-yielding an advanced electrode material with improved structural and electrochemical properties. While many machines may exist to perform the electrospinning techniques described herein, those offered by INOVENSO®, namely its NE300 electrospinning machine, may be optimal to the principles of the disclosure herein.

Now, turning to modified techniques and protocols of those illustrated and described therein FIGS. 5A-B, several example protocols are described below. As may be understood by those having ordinary skill in the art, steps in these protocols may be modified, changed, or transposed, and amounts and types of substances and compounds thereof may be modified, substituted, and/or changed, including by simply increasing and/or decreasing all amounts to create larger amounts of the intended fibrous mats. Specifically, amounts, including weights, voltages, distances and volumes are provided as exemplary only and are not intended to limit the disclosure whatsoever. Indeed, weights and volumes may be especially increased, given a scaled increase in output, which may be beneficial to manufacture of the disclosed batteries at scale.

In a first alternate embodiment of method 550 shown in FIG. 5B, steps 551a (grinding) and 553 (sonication) remain applicable, but this example diverges from steps 552a-c, which specifically reference NMP-based preparations. Instead, water is employed as the primary solvent, and LiTFSI grinding or separate LiTFSI solution preparation may or may not be performed. First alternate embodiment begins by measuring 134 ml of water into a 250 ml beaker. Then while continuously stirring, 27 g of lithium aluminum titanium phosphate (LATP) may be added to the beaker. This parallels grinding step 551a and slurry/solution steps 552a-c in FIG. 5B (though water is substituted for the organic solvent of step 552a). The mixture is then sonicated for 5 minutes to disrupt agglomerates, corresponding to general sonication step 553. Then, 9 g of polyethylene oxide (PEO) is dissolved into the solution/slurry under continuous stirring and the mixture is stirred overnight to ensure full disbursement. Sonication is then performed for a final 6 minutes to achieve a homogeneous slurry (again aligning with step 553, but diverging in that only one slurry is prepared, rather than multiple separate solutions). This step may be critical for ensuring a homogenous solution, which may be important to efficient and reliable electrospinning, as may be understood in the art. Turning to step 555 of FIG. 5B (generating fibrous film(s)), the electrospinning voltage may be set to 25 kV and a needle-to-collector distance of 80 mm may be maintained. Perhaps importantly, use of a wide-diameter nozzle to accommodate the relatively high viscosity of the polymer solution may be beneficial to the production of high-quality fibers. Additionally, adjusting the flow rate to 5 ml/min may also be critical for controlling fiber diameter and morphology. Then, in accordance with step 556 of FIG. 5B, the resultant fibrous mat may be dried and can be further processed (e.g., calendered and cut to size) to form electrode structures suitable for solid-state lithium battery applications. Because this example utilizes an aqueous system rather than the organic solvent routes shown in FIG. 5B (steps 552a-c), it illustrates the versatility of the overall approach-substituting different solvents while still applying the fundamental grinding, sonication, and electrospinning principles. As may be understood and observed, FIG. 6D, described in more detail below is SEM image of a product of the above protocol.

In a second alternate embodiment of method 550 shown in FIG. 5B, steps 551a (grinding LATP) and 553 (sonication) remain applicable, but this example diverges from the DMF-based approach by substituting an NMP-based route as set forth in steps 552a-c. First, LATP is ground using a pestle and mortar to produce a fine powder. Subsequently, 52.25 grams of this ground LATP are combined with a 12% polymer by weight NMP solvent solution in Flask 1. In parallel, 9.45 grams of LiTFSI are dissolved in 15 grams of NMP in Flask 2, while another 8.4 grams of LATP are dispersed in 14 grams of NMP in Flask 3; the solution in Flask 3 is then subjected to one hour of sonication to ensure complete dissolution and/or dispersion. The solution from Flask 2 is gradually added to Flask 1, followed by a controlled addition of the contents from Flask 3. The resultant mixture (i.e., slurry) is left to age overnight. Turning now to step 555 of FIG. 5B, the aged solution is used for electrospinning at a voltage of 30 kV, with an 80 mm target distance and a feed rate of 10 ml/min to form the desired fibers. In accordance with step 556, the resultant fibrous mat may subsequently be dried and further processed (e.g., calendered and cut to size) to yield electrode structures suitable for solid-state lithium battery applications. As may be understood and observed, FIG. 6A, described in more detail below, is a low-magnification image of a product of the above protocol.

In a third alternate embodiment of method 550 shown in FIG. 5B, steps 551a (grinding LATP) and 553 (sonication) remain applicable, but this example diverges from the NMP-based route by employing DMF as the primary solvent. The method begins by finely grinding LATP using a pestle and mortar. In Flask 1, 33 g of the ground LATP are mixed (i.e., dispersed) with a 19% polymer by weight DMF solvent solution, replacing the NMP solvent solution of step 552a. Concurrently, 9.45 g of LiTFSI are dispersed in 15 g of DMF in Flask 2, while another 8.4 g of LATP are dispersed in 14 g of DMF in Flask 3. The slurry in Flask 3 is then sonicated for one hour to ensure homogeneity, in accordance with step 553. Following this, the contents of Flask 2 are slowly incorporated into Flask 1, followed by a cautious addition of the contents from Flask 3. The combined mixture is allowed to mature overnight. Turning now to step 555 of FIG. 5B, the matured mixture is subjected to electrospinning at 30 kV with a collection distance of 80 mm and a delivery rate of 10 ml/min to produce the electrospun fibers. In accordance with step 556, the resultant fibrous mat may then be dried and further processed (e.g., calendered and cut to size) to yield electrode structures suitable for solid-state lithium battery applications. As may be understood and observed, FIG. 6B, described in more detail below, is a SEM image of a product of the above protocol.

In a fourth alternate embodiment of method 550 shown in FIG. 5B, steps 551a (grinding LATP) and 553 (sonication) remain applicable, but this example diverges by employing DMSO as the primary solvent. The preparation commences by grinding 12 g of LATP into a fine powder using a pestle and mortar. In Flask 1, a salt weighing 13.5 g is dissolved in 64 g of DMSO, and subsequently, 9.0 g of a polymer is added to the solution, which is stirred continuously overnight to ensure thorough mixing. Meanwhile, in Flask 2, a suspension is created by dispersing 12.0 g of LATP in 16.0 g of DMSO, and this suspension is subjected to one hour of sonication to achieve uniform dispersion. The suspension from Flask 2 is then incrementally added to the mixture in Flask 1. The combined slurry is allowed to age for an entire day to achieve the desired consistency. Turning now to step 555 of FIG. 5B, the aged slurry is processed using electrospinning at 30 kV with an 80 mm collector distance and a feed rate of 10 ml/min to fabricate the fibers. In accordance with step 556, the resultant fibrous mat may then be dried and further processed (e.g., calendered and cut to size) to form electrode structures suitable for solid-state lithium battery applications. As may be understood and observed, FIG. 6C, described in more detail below, is a SEM image of a product of the above protocol.

In a fifth alternate embodiment of method 550 shown in FIG. 5B, steps 551a (grinding LATP) and 553 (sonication) remain applicable, but this example diverges by employing DMAc as the primary solvent. The fabrication process initiates with the grinding of LATP into a fine powder using a pestle and mortar. In Flask 1, 6.3 grams of a copolymer (e.g., a polymer composed of monomer subunits, including but not limited to vinylene carbonate (VC), 4-Vinyl-1,3-dioxolan-2-one (vinyl ethylene carbonate or VEC), Poly(ethylene glycol) methyl ether methacrylate MW500 (PEGMA500), Poly(ethylene glycol) methyl ether methacrylate MW360 (PEGMA360), Poly(ethylene glycol) methyl ether methacrylate MW1000 (PEGMA1000), Dimethyl vinylphosphonate (DMVP), Butyl cyanoacrylate (BCA), N-Butylacrylate (NBA), Pentafluoropropyl methacrylate (PFMA), Glycidal acrylate (GLA) and Glycidal methacrylate (GMA)) are combined with 70 grams of DMAc. To this mixture, 32.2 grams of LiTSI and 9.8 grams of the previously ground LATP are added. Such proposed copolymers, which may serve as polymer binders for the fibrous mats disclosed herein, and methods of production thereof as may be relevant to those having ordinary skill in the art, have been described in, e.g., U.S. Pat. No. 12,006,387, entitled “POLYMER COMPOSITION AND METHODS FOR MAKING SAME” which is herein incorporated by reference in its entirety. These components are then dispersed into a slurry using a shear homogenizer for 10 minutes to ensure a homogeneous mixture. The slurry is further mixed overnight using a propeller stirrer to achieve complete dissolution and uniformity. Turning now to step 555 of FIG. 5B, the thoroughly mixed slurry is processed through electrospinning by applying a voltage of 30 kV, maintaining an 80 mm distance from the target, and utilizing a feed rate of 10 ml/min to generate the electrospun fibers. In accordance with step 556, the resultant fibrous mat may then be dried and further processed (e.g., calendered and cut to size) to yield electrode structures suitable for solid-state lithium battery applications. As may be understood and observed, FIG. 6E, described in more detail below, is a SEM image of a product of the above protocol.

In a sixth alternate embodiment of the method 550, a cathode is formed via electrospraying using the NE300 instrument from Inovenso. The preparation begins with the slurry formulation for the cathode. Initially, 75 g of CAM is ground to a fine consistency. Once the grinding process is complete, 8 g of a polymer (e.g., a polymer composed of monomer subunits, including but not limited to vinylene carbonate (VC), 4-Vinyl-1,3-dioxolan-2-one (vinyl ethylene carbonate or VEC), Poly(ethylene glycol) methyl ether methacrylate MW500 (PEGMA500), Poly(ethylene glycol) methyl ether methacrylate MW360 (PEGMA360), Poly(ethylene glycol) methyl ether methacrylate MW1000 (PEGMA1000), Dimethyl vinylphosphonate (DMVP), Butyl cyanoacrylate (BCA), N-Butylacrylate (NBA), Pentafluoropropyl methacrylate (PFMA), Glycidal acrylate (GLA) and Glycidal methacrylate (GMA)), and 4-Methylmorpholine (NMM), and 17 g of LiTFSI are added to 70 g of DMSO in Flask 1. This mixture is then subjected to a shear homogenization process to ensure uniform consistency and optimal integration of the components. Further refinement using the shear homogenizer within Flask 1 yields a homogeneous slurry well-suited for electrospraying. Turning now to the electrospraying process, the NE300 instrument is configured with a voltage of 20 kV to generate the appropriate electric force for droplet formation. The distance between the nozzles and the collector is set at 5 cm, facilitating precise droplet deposition, while the system's 12 nozzles enhance the deposition rate and coverage area. The slurry's feed rate is maintained at a consistent 2 ml/h to ensure steady droplet production, and battery-grade aluminum foil is used as the collector to promote efficient adherence and integrity of the sprayed droplets. Importantly to this specific embodiment, detachment from a high-quality aluminum substrate (e.g., collector 606), may be avoided until full drying is achieved may be important to avoid damage. As may be understood and observed, such polymers and/or co-polymers as described above as well as variations thereof may be substituted for any of the polymers and/or polymer binders as may be listed in examples 1-7 as provided herein and FIG. 6F, described in more detail below, is a SEM image of a product of the above protocol.

In a final alternate embodiment of the inventive process, a cathode may be fabricated via a hybrid electrospraying and electrospinning method using the NE300 instrument described above. The process begins with slurry preparation. First, 80 g of cathode active material (CAM) is coarsely ground together with 0.9 g of carbon. In Flask 1, 6.6 g of a polymer (e.g., a polymer composed of monomer subunits, including but not limited to vinylene carbonate (VC), 4-Vinyl-1,3-dioxolan-2-one (vinyl ethylene carbonate or VEC), Poly(ethylene glycol) methyl ether methacrylate MW500 (PEGMA500), Poly(ethylene glycol) methyl ether methacrylate MW360 (PEGMA360), Poly(ethylene glycol) methyl ether methacrylate MW1000 (PEGMA1000), Dimethyl vinylphosphonate (DMVP), Butyl cyanoacrylate (BCA), N-Butylacrylate (NBA), Pentafluoropropyl methacrylate (PFMA), Glycidal acrylate (GLA) and Glycidal methacrylate (GMA)) and an equal amount of LiTFSI are added to 44 g of NMP, forming a preliminary mixture. This mixture is homogenized using a shear homogenizer to ensure a smooth and consistent blend. Thereafter, the ground cathode active material (CAM) and carbon mixture is added to Flask 1 and subjected to further shear homogenization to thoroughly integrate all components. The resultant blend is allowed to age for a full day, permitting the constituents to interact and stabilize prior to subsequent processing. Turning now to the electrospraying/electrospinning step, the NE300 instrument is configured with a voltage finely tuned to 20 kV, which is essential for generating the appropriate electric force for droplet formation. The distance between the nozzles and the collector is maintained at a concise 5 cm, facilitating accurate deposition. Utilizing 12 nozzles significantly amplifies the deposition rate and coverage area, while a consistent feed rate of 2 ml/h ensures a steady flow of the slurry. Battery-grade aluminum foil is employed as the collector, chosen for its efficiency in ensuring that the droplets adhere well and maintain their integrity. Each of these parameters may play a significant role in achieving uniformly sized and well-distributed droplets, thereby contributing to the formation of high-quality electrode structures suitable for solid-state lithium battery applications. Perhaps importantly, care should be taken, as understood by those having ordinary skill in the art, to avoid a development of carbon black, which may shorten circuitry of the resulting cells/battery. As may be understood and observed, FIG. 6G, described in more detail below, is a SEM image of a product of the above protocol.

Turning now to FIGS. 6A-G, a series of micrographs illustrate the diverse outcomes of fiber mat deposition using various solvent systems and operating parameters as may be illustrated and herein described. FIG. 6A presents an optical microscope digital image of a fiber mat obtained via splaying from an NMP-based ceramic slurry, according to, e.g., the protocol provided in the second alternate embodiment protocol described above. While this economical visualization method provides some context to the visual appearance of and overall mat coverage of such a technique, its resolution may be insufficient to discern individual fibers. In contrast, FIGS. 6B-G are SEM images of fiber mats of the disclosure. Beginning with FIG. 6B, imaged therein is a high-resolution SEM image of splayed fibers from a DMF-based slurry, prepared according to, e.g., the protocol provided in the third alternate embodiment protocol described above, offering adequate resolution to clearly view the individual, thin fibers that constitute the mat, which comprises polymer and ceramic additives. FIG. 6C, also a SEM image, may underscore the crucial role of solvent selection by showing poor fiber formation when DMSO is used when the fibrous mat is prepared according to, e.g., the protocol provided in the fourth alternate embodiment protocol described above. FIG. 6D, another SEM image, depicts a randomly oriented fiber mat, which may be prepared according to, e.g., the protocol provided in the first alternate embodiment protocol described above, while FIG. 6E-captured via SEM-shows an excellently aligned mat with larger-diameter fibers when manufactured according to, e.g., the protocol provided in the fifth alternate embodiment protocol described above. Such diameters may be controlled by parameters such as slurry viscosity and the distance between the nozzle and collector, with the fibers incorporating a mix of polymer, lithium salt, and ceramic additive. FIG. 6F, a SEM image, demonstrates that careful control over slurry composition, viscosity, and instrument parameters, according to, e.g., the protocol provided in the sixth alternate embodiment protocol described above, enables differentiation between splaying fibers and spraying particles, with the image exemplifying particle spraying. Finally, FIG. 6G, likewise a SEM image, shows an exemplary hybrid deposition result which may be achieved by operating at the boundary conditions between spraying and splaying, according to, e.g., the protocol provided in the final (seventh) alternate embodiment protocol described above, wherein tiny, thin fibers bond together the sprayed particulates to form a unique microstructure, which may be excellent for lithium metal deposition and/or lithium ion conduction.

With respect to the above description then, it is to be realized that the optimum dimensional relationships, to include variations in size, materials, shape, form, position, function and manner of operation, assembly, type of anode/cathode/battery container, type of connection(s), and use, all of which are intended to be encompassed by the present disclosure. It is contemplated herein that the high energy density lithium metal-based anode, or solid-state anode 111, for solid-state lithium-ion batteries (solid-state battery 100), solid separator 131, and the various parts and components herein described may include a variety of overall sizes and corresponding sizes for and of various parts, including but not limited to: solid-state anode 111, solid electrolyte 112, metal ion deposit 120, solid separator 131, cathode 312, cathode current collector 132 the like and/or combinations thereof. Indeed, those various parts and components of solid-state battery 100 may vary in size, shape, etc. during the standard operation of solid-state battery 100. The description of the high energy density lithium metal-based solid-state anode 111 for solid-state battery 100 in combination with solid separator 131 herein mentions benefits for electric automobiles and other electronic devices, but the invention is not so limited. solid separator 131 for solid-state lithium-ion batteries of the disclosure, as well as batteries manufactured therefrom, may have applications for powering other vehicles, computers, businesses, homes, industrial facilities, consumer and portable electronics, hospitals, factories, warehouses, government facilities, datacenters, emergency backup, aerospace, space travel, robotics, drones, the like and/or combinations thereof. The chemical formulas, metals, atomic and molecular compositions (the “disclosed formulas”) provided herein are exemplary only. One skilled in the art would know that variations of the disclosed formulas may offer tradeoffs to the disclosed solid separator 131 for solid-state lithium-ion batteries and may be substituted to accomplish similar advantages to solid separator 131 for solid-state lithium-ion batteries of the disclosure. Furthermore, it is contemplated that due to variations in materials and manufacturing techniques, including but not limited to polymers, alloys, metals, assembly, tabbing, welding, atmospheric composition, the like and combinations thereof, that a variety of considerations may be considered with regard to battery manufacture. Yet still, though the inventor has contemplated various methods of manufacturing and assembling a battery to accomplish the result(s) of a greater per-mass electric storage capacity (energy density), providing high currents of operation, increasing the durability and longevity of a battery, increasing the range at which a battery may reliably operate, provide a safer battery, and a more efficient means of production, the disclosure is not limited to the specific components, the benefits herein recited and described, and/or the methods of manufacture recited herein. In various embodiments of the present disclosure and in the claims below, numerical values described as ‘approximately,’ ‘about,’ or ‘generally’ are not intended to be strictly limiting but rather are illustrative of typical ranges that may be employed in the practice of the invention. For example, when a voltage of ‘approximately 30 kV’ is recited, this value is intended to cover a range of voltages from about 25 kV to about 35 kV. Similarly, a nozzle-to-collector distance of ‘approximately 80 mm’ is to be understood as covering distances from about 70 mm to about 90 mm, and a feed rate of ‘about 10 ml/min’ is intended to cover rates from about 8 ml/min to about 12 ml/min. Furthermore, where a drying temperature of ‘approximately 60° C.’ is specified, such temperature may vary within a range of approximately 50° C. to 70° C., and drying times described as ‘at least 2 hours’ may be adjusted by an amount known in the art. These ranges are provided solely as guidance and should not be construed as limitations on the scope of the invention.

The foregoing description and drawings comprise illustrative embodiments. Having thus described exemplary embodiments, it should be noted by those skilled in the art that the disclosures herein are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. A method for fabricating a battery electrode for a solid-state lithium-ion battery, the method comprising:
grinding a first amount of a ceramic material to form a fine powder;
preparing a slurry by:
dissolving a second amount of a lithium salt and a third amount of a polymer binder in an organic solvent at a weight to volume ratio;
combining a resulting solution with said fine powder; and
homogenizing a resulting mixture via a sonication for an amount of time to produce said slurry;
depositing said aged slurry by a simultaneous performance of an electrospraying and an electrospinning under a plurality of controlled parameters, thereby forming a hybrid fibrous mat wherein a plurality of sprayed particulates are bonded by a plurality of spun fibers; and
drying said hybrid fibrous mat to yield an electrode having a plurality of lithium conductive polymers and a plurality of inter-fiber spaces.

2. The method of claim 1, wherein said organic solvent is selected from a group of organic solvents, the group consisting of N-methyl-2-pyrrolidone (NMP), dimethylformamide (DMF), dimethyl sulfoxide (DMSO), and dimethylacetamide (DMAc).

3. The method of claim 1, further comprising shear homogenizing said aged slurry during said homogenizing step and aging said aged slurry for a period of at least 12 hours prior to the depositing step.

4. The method of claim 1, wherein said polymer binder is a copolymer, comprising as copolymerized units:
a vinylene carbonate compound as a first monomer; and
at least one additional monomer different from the first monomer and copolymerizable with the first monomer, with the proviso that the at least one additional monomer does not comprise a glycidyl group;
wherein a molar ratio of the first monomer to the at least one additional monomer is from 4:1 to 99:1.

5. The method of claim 4, wherein said at least one additional monomer is selected from a group of monomers, the group consisting of a poly(ethylene glycol) methacrylate (PEGMA), 1,3-propene sultone (PES), bis(2,2,2-trifluoroethyl) maleate (TFM), vinyl ethylene carbonate (VEC), dimethyl vinylphosphonate (DMVP), maleic anhydride (MA), diethylvinylphosphonate (DEVP), diethyl allylphosphonate (DEAP), or N-vinylpyrrolidone (NVP), N-methylmaleimide, vinylene sulfate, vinylene sulfite, vinyl ethylene sulfite, or butadiene sulfone, vinylsulfonic acid (VSA), N,N-dimethylvinylsulfonamide, vinylsulfonyl fluoride, fluoro(vinyl) phosphinic acid, vinylphosphonic acid, 2-vinyl-1,3,2-dioxaphospholane-2-oxide, a metal vinylsulfonate, a metal vinylphosphonate, a metal fluoro(vinyl)phosphinate, 1-vinylpyrrolidin-2-one, 1-vinylpyrrolidine-2,5-dione, vinylboronic acid, a metal trifluoro(vinyl)boronate, 2-vinyl-1,3,2-dioxaborolane-4,5-dione, a metal 2-fluoro-2-vinyl-1,3,2-dioxaborolate-4,5-dione, and 4-Methylmorpholine (NMM).

6. The method of claim 5, wherein said polymer binder further comprises polyethylene oxide (PEO) and said lithium salt comprises lithium bis(trifluoromethanesulfonyl)imide (LiTFSI).

7. A method for fabricating a battery electrode for a solid-state lithium-ion battery, the method comprising:
grinding a first amount of ceramic material to form a fine powder;
preparing an aged slurry by:
dissolving a second amount of a lithium salt and a third amount of a polymer binder in an organic solvent at a weight to volume ratio;
combining a resulting solution with said fine powder to produce a mixture; and
sonicating said mixture for a time to produce said aged slurry;
depositing said aged slurry by electrospraying, wherein a high electric field is applied to form a Taylor cone at a spinneret tip and induce a splitting of a jet into a plurality of sub-filaments, thereby forming a fibrous mat comprising a plurality of splayed fibers; and
processing said fibrous mat by drying to yield an electrode having a plurality of lithium-conductive fibers and a plurality of inter-fiber spaces.

8. The method of claim 7, wherein said organic solvent is selected from a group of organic solvents, the group consisting of N-methyl-2-pyrrolidone (NMP), dimethylformamide (DMF), dimethyl sulfoxide (DMSO), dimethylacetamide (DMAc), and water.

9. The method of claim 7, wherein said polymer binder is a copolymer, comprising as copolymerized units:
a vinylene carbonate compound as a first monomer; and
at least one additional monomer different from the first monomer and copolymerizable with the first monomer, with the proviso that the at least one additional monomer does not comprise a glycidyl group;
wherein a molar ratio of the first monomer to the at least one additional monomer is from 4:1 to 99:1.

10. The method of claim 9, wherein said at least one additional monomer is selected from the group consisting of a poly(ethylene glycol) methacrylate (PEGMA), 1,3-propene sultone (PES), bis(2,2,2-trifluoroethyl) maleate (TFM), vinyl ethylene carbonate (VEC), dimethyl vinylphosphonate (DMVP), maleic anhydride (MA), diethylvinylphosphonate (DEVP), diethyl allylphosphonate (DEAP), or N-vinylpyrrolidone (NVP), N-methylmaleimide, vinylene sulfate, vinylene sulfite, vinyl ethylene sulfite, or butadiene sulfone, vinylsulfonic acid (VSA), N,N-dimethylvinylsulfonamide, vinylsulfonyl fluoride, fluoro(vinyl) phosphinic acid, vinylphosphonic acid, 2-vinyl-1,3,2-dioxaphospholane-2-oxide, a metal vinylsulfonate, a metal vinylphosphonate, a metal fluoro(vinyl)phosphinate, 1-vinylpyrrolidin-2-one, 1-vinylpyrrolidine-2,5-dione, vinylboronic acid, a metal trifluoro(vinyl)boronate, 2-vinyl-1,3,2-dioxaborolane-4,5-dione, a metal 2-fluoro-2-vinyl-1,3,2-dioxaborolate-4,5-dione, and 4-Methylmorpholine (NMM).

11. The method of claim 10, wherein a collector is covered by a high-grade aluminum foil.

12. The method of claim 11, wherein said fibrous mat remains on said high-grade aluminum foil until drying is complete.

13. The method of claim 12, where drying occurs at approximately 60° C. for a period of at least 2 hours.

14. The method of claim 13, further comprising incorporating said electrode into a solid-state lithium-ion battery, wherein the battery comprises said electrode produced by the method of claim 13, a counter-electrode, a separator, and a solid electrolyte.

15. The method of claim 10, wherein said lithium salt comprises lithium bis(trifluoromethanesulfonyl)imide (LiTFSI) and said polymer binder further comprises polyethylene oxide (PEO).

16. A solid-state lithium-ion battery comprising:
an electrode formed of a fibrous mat having a plurality of lithium-conductive fibers and a plurality of inter-fiber spaces, wherein said electrode is produced by a method comprising:
grinding a first amount of a ceramic material to form a fine powder;
preparing an aged slurry by:
dissolving a second amount of a lithium salt and a third amount of a polymer binder in an organic solvent at a weight-to-volume ratio to form a solution;
combining said solution with said fine powder, and sonicating the mixture for a time to produce an aged slurry; and
depositing said aged slurry by electrospraying, wherein a high electric field is applied to form a Taylor cone at a spinneret tip and induce splitting of a jet into a plurality of sub-filaments, thereby forming said fibrous mat;
a counter-electrode;
a separator; and
a solid electrolyte.

17. The battery of claim 16, wherein said organic solvent is selected from the group consisting of N-methyl-2-pyrrolidone (NMP), dimethylformamide (DMF), dimethyl sulfoxide (DMSO), and dimethylacetamide (DMAc), said lithium salt comprises lithium bis(trifluoromethanesulfonyl)imide (LiTFSI) and said polymer binder comprises polyethylene oxide (PEO).

18. The battery of claim 16, wherein said polymer binder is a copolymer, comprising as copolymerized units:
a vinylene carbonate compound as a first monomer; and
at least one additional monomer different from the first monomer and copolymerizable with the first monomer, with the proviso that the at least one additional monomer does not comprise a glycidyl group;
wherein a molar ratio of the first monomer to the at least one additional monomer is from 4:1 to 99:1.

19. The battery of claim 16, wherein the at least one additional monomer is selected from the group consisting of a poly(ethylene glycol) methacrylate (PEGMA), 1,3-propene sultone (PES), bis(2,2,2-trifluoroethyl) maleate (TFM), vinyl ethylene carbonate (VEC), dimethyl vinylphosphonate (DMVP), maleic anhydride (MA), diethylvinylphosphonate (DEVP), diethyl allylphosphonate (DEAP), or N-vinylpyrrolidone (NVP), N-methylmaleimide, vinylene sulfate, vinylene sulfite, vinyl ethylene sulfite, or butadiene sulfone, vinylsulfonic acid (VSA), N,N-dimethylvinylsulfonamide, vinylsulfonyl fluoride, fluoro(vinyl) phosphinic acid, vinylphosphonic acid, 2-vinyl-1,3,2-dioxaphospholane-2-oxide, a metal vinylsulfonate, a metal vinylphosphonate, a metal fluoro(vinyl)phosphinate, 1-vinylpyrrolidin-2-one, 1-vinylpyrrolidine-2,5-dione, vinylboronic acid, a metal trifluoro(vinyl)boronate, 2-vinyl-1,3,2-dioxaborolane-4,5-dione, and a metal 2-fluoro-2-vinyl-1,3,2-dioxaborolate-4,5-dione.

20. The battery of claim 16, wherein a collector is covered by a battery-grade aluminum foil and said fibrous mat remains on said battery-grade aluminum foil until drying is complete.
